(19) United States
(12) Patent Application Publication
(10) Pub. No.: US 2012/0163537 A1
(43) Pub. Date: Jun. 28, 2012

(54) RADIOGRAPHIC IMAGE OBTAINMENT METHOD AND RADIOGRAPHIC APPARATUS

(75) Inventors: Naoto IWAKIRI, Ashigarakami-gun (JP); Hiroyasu ISHII, Ashigarakami-gun (JP)

(73) Assignee: FUJIFILM CORPORATION, Tokyo (JP)

(21) Appl. No.: 13/337,766

(22) Filed: Dec. 27, 2011

(30) Foreign Application Priority Data
Dec. 27, 2010 (JP) 2010-289134
Dec. 26, 2011 (JP) 2011-283438

(51) Int. Cl. G01N 23/04

(52) U.S. Cl. 378/62

(57) ABSTRACT

In a radiographic apparatus, a radiation image detector or first and second gratings are structured in such a manner to be attachable to the radiographic apparatus and detachable therefrom. The radiographic apparatus includes a cassette attachment/detachment detection unit that detects attachment and detachment of the radiation image detector, or a grid attachment/detachment detection unit that detects attachment and detachment of the first and second gratings. The apparatus further includes a preliminary irradiation control unit that controls a radiation source so that preliminary irradiation for detecting a relative positional deviation between the first and second gratings and the radiation image detector is performed when attachment or detachment of the radiation image detector, or the first and second gratings has been detected.

### BACKGROUND OF THE INVENTION

1. Field of the Invention

The present invention relates to a radiographic image obtainment method and a radiographic apparatus using a grating or gratings.

2. Description of the Related Art

Since X-rays attenuate depending on the atomic number of an element constituting a substance through which the X-rays pass, and the density and the thickness of the substance, the X-rays are used as a probe for observing the inside of a subject from the outside of the subject. X-ray radiography is widely used in medical diagnosis, non-destructive examination, and the like.

In a general X-ray radiography system, a subject is placed between an X-ray source for emitting X-rays and an X-ray image detector for detecting an X-ray image. In this state, radiography is performed on the subject to obtain a transmission image of the subject. In this case, each X-ray emitted from the X-ray source toward the X-ray image detector attenuates (is absorbed) by an amount based on a difference in the properties (atomic number, density, and thickness) of a substance or substances constituting the subject that is present in a path to the X-ray image detector, and the attenuated X-rays are incident on the X-ray image detector. Consequently, an X-ray transmission image of the subject is detected by the X-ray image detector, and an image is formed. As the X-ray image detector, a combination of an X-ray sensitizing screen and a film, or a photostimulable phosphor is used. Further, a flat panel detector (FPD) using a semiconductor circuit is widely used.

However, the X-ray absorptivity of a substance is lower as the atomic number of an element constituting the substance is smaller. Since a difference in X-ray absorptivity is small in soft tissue of a living body, soft material, and the like, a sufficient difference in intensity (contrast) as an X-ray transmission image is not obtainable. For example, both of articular cartilage constituting a joint in a human body and synovial fluid around the cartilage are mostly composed of water. Therefore, a difference in X-ray absorptivity between the two is small, and a sufficient contrast in an image is hard to obtain.

In recent years, X-ray phase contrast imaging has been studied. In X-ray phase contrast imaging, a phase contrast image based on a shift in the phase of X-ray wave-front caused by a difference in the refractive index of a subject to be examined is obtained, instead of an image based on a change in the intensity of X-rays caused by a difference in the absorption coefficient of the subject. In the X-ray phase contrast imaging using the phase difference, high contrast images are obtainable even if the subject is a low absorption object, which has low X-ray absorptivity.

X-ray phase contrast imaging is a new imaging method utilizing X-ray phase/refraction information, and is capable of imaging a soft tissue which is difficult to be imaged by the conventional imaging method based on X-ray absorption due to a small difference in X-ray absorptivity that produces substantially no difference in contrast between the images of such tissues.

Conventionally, MRI could obtain images of such soft tissues. However, imaging by MRI has problems of a long imaging time of several tens of minutes, a low image resolution of about 1 mm, and a low cost-effectiveness which is difficult to be adopted in regular checkups of physical examination.

So far, imaging of such tissues in X-ray phase contrast imaging has been possible by monochromatic X-rays with well-aligned phase generated from a large synchrotron radiation facility (for example, SPring-8 in Hyogo Prefecture, Japan) or the like. However, such a facility is too large to be adopted in general hospitals.

X-ray phase contrast imaging can show an image of cartilage and soft tissue portions, which are difficult to be identifiable in an X-ray absorption image as described above. Therefore, quick and easy diagnosis of an abnormality by X-rays is possible by X-ray phase contrast imaging. Specifically, diagnosis of a disorder in a joint, such as knee osteoarthritis, rheumatoid arthritis, sports injury, such as a damage to a meniscus, a tendon, or ligaments, and an abnormality, such as a tumor for a breast cancer, and the like is possible. Therefore, X-ray phase contrast imaging will be contributable to early detection in diagnosis and early treatment of latent patients in the coming aged society, and reduction in medical expenses.

In the X-ray phase contrast imaging, for example, an X-ray phase contrast imaging apparatus has been proposed, in which two gratings, namely, a first grating and a second grating are arranged parallel to each other with a predetermined distance therebetween. Further, self image G1 of the first grating is formed at the position of the second grating by a Talbot interference effect. Further, the second grating modulates the intensity of the self image G1 to obtain an X-ray phase contrast image.

Here, the angle of refraction of X-rays induced by a phase shift of the X-ray wave-front by interactiong with a subject, especially soft tissue, is a few μrad at most. Further, it is necessary to measure a position shift amount (displacement amount) of X-rays induced by the refraction, and which is typically a few μm approximately, to provide a sufficient image contrast for identifying such tissue. However, the pixel pitch of a radiation image detector is typically in the range of tens of μm to hundreds of μm. Therefore, it is extremely difficult to directly measure the shift in the position. Hence, in the X-ray phase contrast imaging apparatus as described above, image acquisition is performed each time when one of two gratings is moved relative to the other grating in the arrangement direction of the gratings, and a change in moiré fringes generated by the two gratings is measured. Specifically, a phase shift amount of moiré fringes is analyzed by using a method that is generally called as fringe scan to measure the tiny angle of refraction as described above. However, since the phase shift amount of moiré fringes is also very small, a small fluctuation of the moiré image greatly affects the phase restoration accuracy.

Meanwhile, various cassettes for radiography, in which a radiation image detector and the like are housed in a small case, have been proposed. The cassettes for radiography are convenient, because they are thin and in conveyable size. Further, a cassette for radiography having appropriate size and shape is available based on the size and the kind of a subject. The cassette for radiography is structured in such a manner to be attachable to a radiographic apparatus and detachable therefrom, and an appropriate cassette based on the condition of the subject is mountable in the radiographic apparatus. In the X-ray phase contrast imaging apparatus, such a cassette for radiography may be used.

Further, the first grating and the second grating of the X-ray phase contrast imaging apparatus are in various sizes based on the size of a subject or the like. The first grating and the second grating may be attachable to the X-ray phase contrast imaging apparatus and detachable therefrom in a manner similar to the radiation image detector. The first grating and second grating may be changed based on the purpose of examination. Further, when the first grating and the second grating are attachable/detachable, the X-ray phase contrast imaging apparatus can be structured in such a manner that both of radiography for obtaining an X-ray phase contrast image and radiography for obtaining an ordinary absorption image are possible.

However, when the cassette and the attachable/detachable first and second gratings, as described above, are used in the X-ray phase contrast imaging apparatus, a relative positional deviation (misregistration, misalignment, shift, displacement or the like) is generated between the radiation image detector and the first and second gratings each time when they are attached or detached. Further, since a cassette attaching/detaching mechanism or the like is to be designed with a certain clearance therebetween, it is extremely difficult to match the position in the order of μm every time when the cassette or the like is attached or detached.

When such a relative positional deviation is generated, misalignment occurs between the arrangement of pixels of a radiation image detector and the first and second gratings, and consequently, moiré is generated depending on the angle between the first and second gratings and the arrangement of pixels of the radiation image detector, or the distance between the first and second gratings and the radiation image detector.

The moiré generated by a positional deviation between the arrangement of pixels of the radiation image detector and the first and second gratings causes an operation error when a phase contrast image is reconstructed. This lowers image contrast and resolution, and an artifact is generated by the moiré that is not completely removable. Consequently, a risk of lowering the accuracy of diagnosis increases.

A relative positional deviation between the radiation image detector and the first and second gratings greatly affects a phase contrast image. The influence on the phase contrast image is much greater than an influence on ordinary still image or dynamic image radiography using X-rays, in which an image is not constructed by an operation based on a small difference among plural images. Further, the influence on the phase contrast image is greater than an influence on CT (Computed Tomography), tomosynthesis or the like, in which an image is reconstructed after radiography is performed on a subject plural times while the incident angle of X-rays entering the subject is changed.

The influence of relative positional deviation on the phase contrast image is great, because image acquisition for the phase contrast image as described above is performed while the grating is moved without changing the incident angle of X-rays entering the subject, and a tiny position shift of X-rays of approximately a few μm on a radiation image detector caused by a phase shift of the X-ray wave-front is measured based on the small difference among plural moiré images. Meanwhile, in an energy subtraction image, the images of soft tissues, bones and the like are separately reconstructed from the images of a subject obtained by irradiating with each different X-ray energy at the same incident angle to the subject. In the energy subtraction image, because the contrast of the image of a subject greatly changes depending on X-ray energy irradiated to the subject, an influence on the phase contrast image by a tiny change in the images is also greater in comparison with the energy subtraction image.

Meanwhile, U.S. Patent Application Publication No. 20100080436 (Patent Document 1) fails to teach or suggest that moiré generated by attachment or detachment of a cassette or the like greatly lowers the quality of a reconstructed image, as described above. Further, Patent Document 1 fails to propose any measure to cope with the moiré.

### SUMMARY OF THE INVENTION

In view of the foregoing circumstances, it is an object of the present invention to provide a radiographic image obtainment method in a radiographic apparatus structured in such a manner that a radiation image detector or first and second gratings are attachable to the radiographic apparatus and detachable therefrom. Specifically, it is an object of the present invention to provide the radiographic image obtainment method and apparatus that can reduce an influence of moiré generated by misalignment between the radiation image detector and the first and second gratings, and which can obtain a higher quality image for diagnosis.

A radiographic apparatus of the present invention is a radiographic apparatus comprising:

a first grating in which a grating structure is periodically arranged, and that forms a first periodic pattern image by passing radiation that has been emitted from a radiation source;

a second grating in which a grating structure is periodically arranged, and that forms a second periodic pattern image by receiving the first periodic pattern image; and

a radiation image detector that detects the second periodic pattern image formed by the second grating,

wherein the first grating and the second grating are structured in such a manner to be attachable to the radiographic apparatus and detachable therefrom, and

the radiographic apparatus further comprising:

a grid attachment/detachment detection unit that detects attachment and detachment of the first and second gratings; and

a preliminary irradiation control unit that controls the radiation source so that preliminary irradiation for detecting a relative positional deviation between the first and second gratings and the radiation image detector is performed when the grid attachment/detachment detection unit has detected attachment or detachment of the first and second gratings.

A radiographic apparatus of the present invention is a radiographic apparatus comprising:

a first grating in which a grating structure is periodically arranged, and that forms a first periodic pattern image by passing radiation that has been emitted from a radiation source;

a second grating in which a grating structure is periodically arranged, and that forms a second periodic pattern image; and

a radiation image detector that detects the second periodic pattern image formed by the second grating,

wherein the radiation image detector is structured in such a manner to be attachable to the radiographic apparatus and detachable therefrom, and

the radiographic apparatus further comprising:

a detector attachment/detachment detection unit that detects attachment and detachment of the radiation image detector; and

a preliminary irradiation control unit that controls the radiation source so that preliminary irradiation for detecting a relative positional deviation between the first and second gratings and the radiation image detector is performed when the detector attachment/detachment detection unit has detected attachment or detachment of the radiation image detector.

In the radiographic apparatus of the present invention, the preliminary irradiation control unit may notify that the preliminary irradiation will be performed when attachment or detachment of the first and second gratings is detected. Further, when the preliminary irradiation control unit has received an instruction to start preliminary irradiation after the notification, the preliminary irradiation control unit may perform the preliminary irradiation.

In the radiographic apparatus of the present invention, the preliminary irradiation control unit may notify that the preliminary irradiation will be performed when attachment or detachment of the radiation image detector is detected. Further, when the preliminary irradiation control unit has received an instruction to start preliminary irradiation after the notification, the preliminary irradiation control unit may perform the preliminary irradiation.

Further, a person detection unit that detects whether no person is in a predetermined distance range may be provided, and the preliminary irradiation control unit may perform the preliminary irradiation when attachment or detachment of the first and second gratings is detected and when the person detection unit has detected that no person is in the predetermined distance range.

Further, a person detection unit that detects whether no person is in a predetermined distance range may be provided, and the preliminary irradiation control unit may perform the preliminary irradiation when attachment or detachment of the radiation image detector is detected and when the person detection unit has detected that no person is in the predetermined distance range.

The radiographic apparatus of the present invention may further include a position shift information obtainment unit that obtains information related to relative positional deviation between the first and second gratings and the radiation image detector based on an image for checking position shift that has been detected by the radiation image detector by the preliminary irradiation.

The radiographic apparatus of the present invention may further include a position adjustment mechanism that adjusts the position of the first and second gratings or the radiation image detector based on the information related to relative positional deviation obtained by the position shift information obtainment unit.

The position shift information obtainment unit may obtain, as the information related to relative positional deviation, a frequency component of moiré generated in the image for checking position shift by the relative positional deviation between the first and second gratings and the radiation image detector.

The radiographic apparatus of the present invention may further include a scan mechanism that moves at least one of the first grating and the second grating in a direction orthogonal to a direction in which the at least one of the first grating and the second grating extends, and an image generation unit that generates an image by using a plurality of radiographic image signals, each representing the second periodic pattern image detected by the radiation image detector with respect to each position of the at least one of the first grating and the second grating, while the at least one of the first grating and the second grating is moved by the scan mechanism.

Further, the first grating and the second grating may be arranged in such a manner that a direction in which the first periodic pattern of the first grating extends and a direction in which the second grating extends incline relative to each other, and the radiographic apparatus of the present invention may further include an image generation unit that generates an image by using a radiographic image signal detected by the radiation image detector by irradiating a subject with the radiation.

Further, the image generation unit may obtain, based on the radiographic image signal detected by the radiation image detector, radiographic image signals read out from different groups of pixel rows as radiographic image signals representing fringe images different from each other, and generate the image based on the obtained radiographic image signals representing the plurality of fringe images.

The radiographic apparatus of the present invention may further include an image generation unit that performs Fourier transformation on a radiographic image signal detected by the radiation image detector by irradiating a subject with the radiation, and generates an image based on the result of the Fourier transformation.

A radiographic image obtainment method of the present invention is a radiographic image obtainment method for obtaining a radiographic image by using a radiographic apparatus including:

a first grating in which a grating structure is periodically arranged, and that forms a first periodic pattern image by passing radiation that has been emitted from a radiation source;

a second grating in which a grating structure is periodically arranged, and that forms a second periodic pattern image by receiving the first periodic pattern image; and

a radiation image detector that detects the second periodic pattern image formed by the second grating,

wherein the first grating and the second grating are structured in such a manner to be attachable to the radiographic apparatus and detachable therefrom, and

wherein the radiation source is controlled so that preliminary irradiation for detecting a relative positional deviation between the first and second gratings and the radiation image detector is performed when attachment or detachment of the first and second gratings is detected.

A radiographic image obtainment method of the present invention is a radiographic image obtainment method for obtaining a radiographic image by using a radiographic apparatus including:

a first grating in which a grating structure is periodically arranged, and that forms a first periodic pattern image by passing radiation that has been emitted from a radiation source;

a second grating in which a grating structure is periodically arranged, and that forms a second periodic pattern image by receiving the first periodic pattern image; and

a radiation image detector that detects the second periodic pattern image formed by the second grating,

wherein the radiation image detector is structured in such a manner to be attachable to the radiographic apparatus and detachable therefrom, and

wherein the radiation source is controlled so that preliminary irradiation for detecting a relative positional deviation between the first and second gratings and the radiation image detector is performed when attachment or detachment of the radiation image detector is detected.

According to a radiographic image obtainment method and a radiographic apparatus of the present invention, the first and second gratings and/or the radiation image detector is structured in such a manner that they are attachable to the radiographic apparatus and detachable therefrom. Further, when attachment or detachment of the first and second gratings and/or the radiation image detector is detected, a radiation source is controlled so as to perform preliminary irradiation to detect a relative positional deviation (shift in position, misregistration, misalignment, displacement or the like) between the first and second gratings and the radiation image detector. Therefore, for example, if a position shift is detected based on an image for checking position detected by the radiation image detector by the preliminary irradiation, and the positions of the first and second gratings or the position of the radiation image detector is adjusted to reduce the position shift, it is possible to reduce the influence of moiré generated by the position shift between the radiation image detector and the first and second gratings. Consequently, a higher quality radiographic image is obtainable.

Further, if a frequency component of moiré generated in the image for checking position shift by the relative positional deviation between the first and second gratings and the radiation image detector is obtained as information related to position shift, it is possible to more easily obtain a position shift amount.

### BRIEF DESCRIPTION OF THE DRAWINGS

FIG. 1 is a schematic diagram illustrating the configuration of a mammography and display system using an embodiment of a radiographic apparatus of the present invention;

FIG. 2 is a schematic diagram illustrating a radiation source, first and second gratings, and a radiation image detector extracted from a mammography apparatus illustrated in FIG. 1;

FIG. 3 is a top view of the radiation source, the first and second gratings and the radiation image detector illustrated in FIG. 2;

FIG. 4 is a schematic diagram illustrating the structure of the first grating;

FIG. 5 is a schematic diagram illustrating the structure of the second grating;

FIG. 6 is a block diagram illustrating the internal configuration of a computer in the mammography and display system illustrated in FIG. 1;

FIG. 7 is a flow chart for explaining an action of a mammography and display system using an embodiment of a radiographic apparatus of the present invention;

FIG. 8A is a diagram for explaining a rotation shift amount of a radiation image detector;

FIG. 8B is a diagram for explaining a rotation shift amount of a radiation image detector;

FIG. 8C is a diagram for explaining a rotation shift amount of a radiation image detector;

FIG. 9 is a diagram illustrating an example of a moiré image generated by a shift in arrangement of the radiation image detector only in Z direction;

FIG. 10 is a diagram illustrating an example of a moiré image generated only by rotation shift ez of the radiation image detector;

FIG. 11 is an example of a frequency component of a moiré image in a frequency space;

FIG. 12 is a diagram for explaining an example of a method for adjusting a first grating or a second grating;

FIG. 13 is a diagram illustrating an example of distribution of frequency components of a moiré image generated by rotation shift θx, θy of the second grating in a frequency space;

FIG. 14A is a diagram illustrating profiles of the distribution of frequency components illustrated in FIG. 13 in a horizontal direction;

FIG. 14B is a diagram illustrating profiles of the distribution of frequency components illustrated in FIG. 13 in a vertical direction;

FIG. 15 is a diagram for explaining a method for calculating rotation shift θx of the radiation image detector;

FIG. 16 is a diagram illustrating an example of a moiré image generated by rotation shift θx, θy of the radiation image detector;

FIG. 17 is a diagram illustrating an example of a path of a radiation ray refracted based on phase shift distribution Φ(x) related to X direction of a subject to be examined;

FIG. 18 is a diagram for explaining translational motion of the second grating;

FIG. 19 is a diagram for explaining a method for generating a phase contrast image;

FIG. 20 is a schematic diagram illustrating the configuration of a mammography and display system using another embodiment of the radiographic apparatus of the present invention;

FIG. 21 is a flow chart for explaining an action of the mammography and display system illustrated in FIG. 20;

FIG. 22 is a diagram illustrating arrangement relationships among a self image of the first grating, the second grating and pixels on the radiation image detector when plural fringe images are obtained by performing one image acquisition operation;

FIG. 23 is a diagram for explaining a method for setting an inclination angle of the self image of the first grating with respect to the second grating;

FIG. 24 is a diagram for explaining a method for adjusting the inclination angle of the self image of the first grating with respect to the second grating;

FIG. 25 is a diagram for explaining an action for obtaining plural fringe images based on image signals read out from the radiation image detector;

FIG. 26 is a diagram for explaining an action for obtaining plural fringe images based on image signals read out from the radiation image detector;

FIG. 27A is a diagram illustrating an example of a radiation image detector having a function of the second grating;

FIG. 27B is a diagram illustrating an example of a radiation image detector having a function of the second grating;

FIG. 27C is a diagram illustrating an example of a radiation image detector having a function of the second grating;

FIG. 28A is a diagram for explaining an action for recording a radiographic image at the radiation image detector illustrated in FIGS. 27A through 27C:

FIG. 28B is a diagram for explaining an action for recording a radiographic image at the radiation image detector illustrated in FIGS. 27A through 27C:

FIG. 29 is a diagram for explaining an action for reading out a radiographic image at the radiation image detector illustrated in FIGS. 27A through 27C;

FIG. 30 is a diagram illustrating another example of the radiation image detector having a function of the second grating;

FIG. 31A is a diagram for explaining an action for recording a radiographic image at the radiation image detector illustrated in FIG. 30;

FIG. 31B is a diagram for explaining an action for recording a radiographic image at the radiation image detector illustrated in FIG. 30;

FIG. 32 is a diagram for explaining an action for reading out a radiographic image at the radiation image detector illustrated in FIG. 30;

FIG. 33 is a diagram illustrating another shape of a charge storage layer in the radiation image detector illustrated in FIG. 30;

FIG. 34 is a diagram for explaining a method for generating an absorption image and a small-angle scattering image;

FIG. 35A is a diagram for explaining a structure in which the first grating and the second grating are rotated by 90°; and

FIG. 35B is a diagram for explaining a structure in which the first grating and the second grating are rotated by 90°.

### DESCRIPTION OF THE PREFERRED EMBODIMENTS

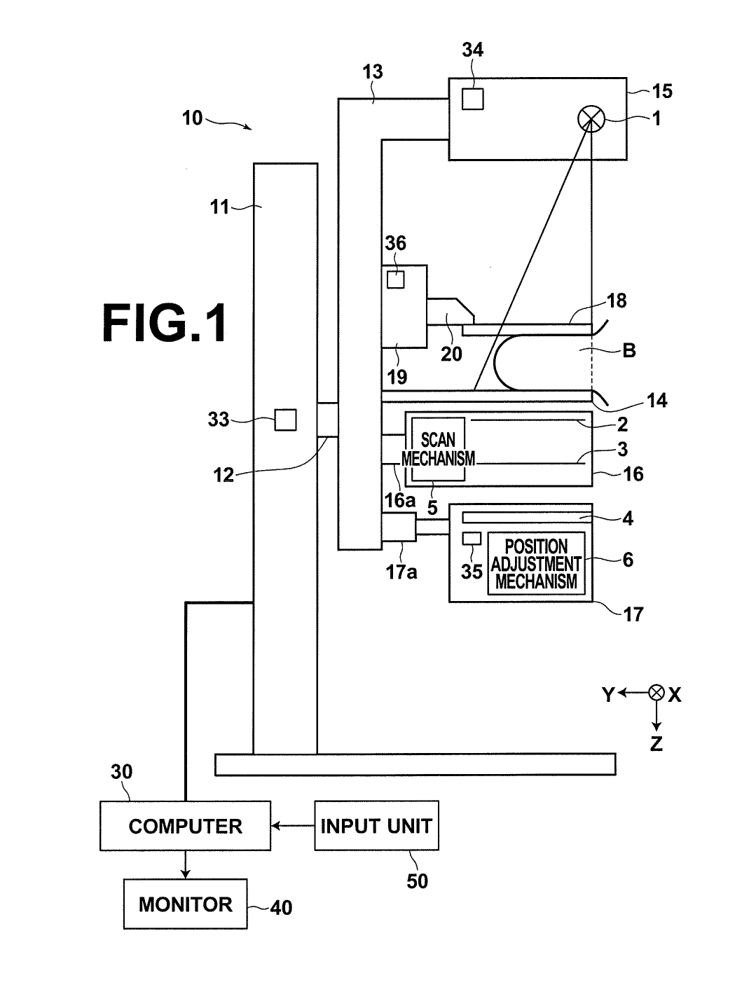

Hereinafter, a mammography and display system using an embodiment of a radiographic apparatus according to the present invention will be described with reference to drawings. FIG. 1 is a schematic diagram illustrating the configuration of the whole mammography and display system using an embodiment of the present invention.

As illustrated in FIG. 1, the mammography and display system of the present invention includes a mammography apparatus 10, a computer 30 connected to the mammography apparatus 10, a monitor 40 and an input unit 50. The monitor 40 and the input unit 50 are connected to the computer 30.

As illustrated in FIG. 1, the mammography apparatus 10 includes a base 11, a rotation shaft 12, and an arm 13. The rotation shaft 12 is movable in a vertical direction (Z direction) with respect to the base 11, and rotatable. The arm 13 is connected to the base 11 by the rotation shaft 12.

The arm 13 is alphabet “C” shaped. A radiography table 14 on which breast B is to be set is provided on one side of the arm 13, and a radiation source unit 15 is provided on the other side of the arm 13 in such a manner to face the radiography table 14. The vertical movement of the arm 13 is controlled by an arm controller 33, which is integrated into the base 11.

Further, a grid unit 16 and a cassette unit 17 are arranged, in this order from the radiography table 14 side, on one side of the radiography table 14 opposite to a breast setting surface of the radiography table 14.

The grid unit 16 is connected to the arm 13 through a grid support unit 16a that supports the grid unit 16, and the grid unit 16 is attachable to the grid support unit 16a and detachable therefrom. Further, a first grating 2, a second grating 3 and a scan mechanism 5, which will be described later, are provided in the grid unit 16. In the present embodiment, the apparatus is structured in such a manner that the grid unit 16 is attachable and detachable, in other words, the grid unit 16 is attachable to the grid support unit 16a and detachable therefrom. However, it is not necessary that the apparatus is structured in such a manner. For example, the apparatus may be structured in such a manner that the grid unit 16 attached to the arm 13 is temporarily removable from the optical path of radiation. The grid unit 16 may be structured in such a manner to be attachable by setting the grid unit 16 on the optical path of radiation, and to be detachable by moving the grid unit 16 from the optical path of radiation to a wait position. Specifically, the structure in which the grid unit 16 is attachable and detachable is not limited to a structure in which the grid unit 16 is attachable to the arm 13 and detachable therefrom, but includes the aforementioned structure, in which the grid unit 16 is temporarily removable from the optical path of radiation.

In the present embodiment, plural kinds of grid units 16 that have different sizes or the like from each other are attachable and detachable.

The cassette unit 17 is connected to the arm 13 through a cassette support unit 17a. The cassette support unit 17a supports the cassette unit 17, and the cassette unit 17 is attachable to the cassette support unit 17a and detachable therefrom. In the present embodiment, the apparatus is structured in such a manner that the cassette unit 17 is attachable and detachable, in other words, the cassette unit 17 is attachable to the cassette support unit 17a and detachable therefrom. However, the apparatus is not limited to such a structure. For example, the cassette unit 17 may be structured in a manner similar to the grid unit 16. Specifically, the apparatus may be structured in such a manner that the cassette unit 17 attached to the arm 13 is temporarily removed from the optical path of radiation. The cassette unit 17 may be structured in such a manner to be attachable by setting the cassette unit 17 on the optical path of radiation, and to be detachable by moving the cassette unit 17 from the optical path of radiation to a wait position.

In the present embodiment, plural kinds of cassette units 17 that have different sizes or the like from each other are attachable and detachable.

Further, a radiation image detector 4, such as a flat panel detector, a detector controller 35, and a position adjustment mechanism 6 are provided in the cassette unit 17. The detector controller 35 controls readout of charge signals or the like from the radiation image detector 4, and the position adjustment mechanism 6 adjusts the position of the radiation image detector 4. Further, a charge amplifier, a correlative double sampling circuit, a circuit board on which an AD converter or the like is provided, and the like are not illustrated, but provided in the cassette unit 17. The charge amplifier converts charge signals read out from the radiation image detector 4 into voltage signals. The correlative double sampling circuit performs sampling on the voltage signals output from the charge amplifier. The AD converter converts the voltage signals into digital signals.

In the radiation image detector 4, pixels are two-dimensionally arranged, and the radiation image detector 4 can repeat recording and readout of radiographic images. As the radiation image detector 4, a so-called direct-type radiation image detector may be used. The direct-type radiation image detector directly converts radiation into charges. Alternatively, a so-called indirect-type radiation image detector may be used. The indirect-type radiation image detector temporarily converts radiation to visible light, and converts the visible light to charge signals. As a method for reading out radiographic image signals, it is desirable to use a so-called TFT readout method or a so-called optical readout method. In the TFT readout method, radiographic image signals are read out by turning a TFT (thin film transistor) switch on or off. In the optical readout method, radiographic image signals are read out by illumination with readout light. However, the method for reading out radiographic image signals is not limited to these methods, and a different method may be used. When an optical-readout-type radiation image detector in which many linear electrodes are provided, and which is scanned with linear readout light in a direction in which the linear electrodes extend to read out image signals, is used, it is regarded that each linear electrode for reading out a signal for one pixel constitutes a pixel row, and that the readout pitch of the readout light constitutes a pixel column.

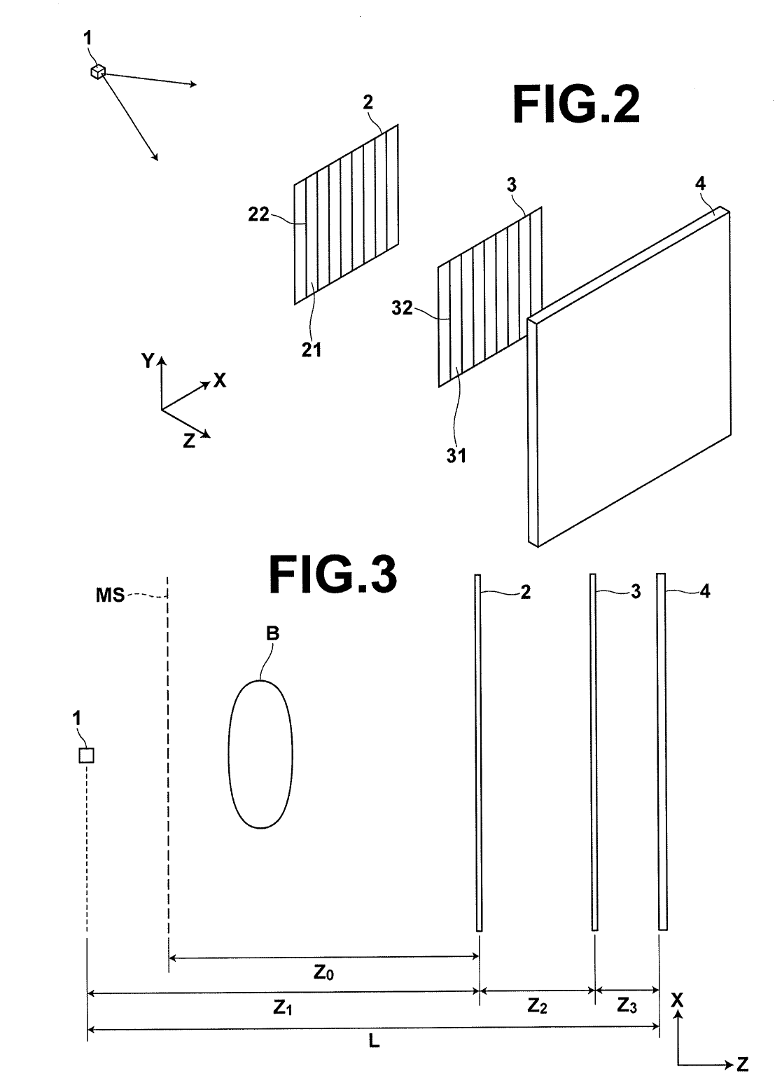

The position adjustment mechanism 6 moves the radiation image detector 4 in X direction and Y direction (please refer to FIGS. 1 and 2), which are in-plane directions of a detection surface of the radiation image detector 4, and orthogonal to each other. Further, the position adjustment mechanism 6 rotates the radiation image detector 4 arround the axis Z which is perpendicular to the detection surface, (please refer to FIGS. 1 and 2). The position adjustment mechanism 6 moves the radiation image detector 4 in such a manner to correct a relative positional deviation between the first and second gratings 2, 3 in the grid unit 16 and the radiation image detector 4 in the cassette unit 17. For example, the position adjustment mechanism 6 is composed of a known actuator, such as a piezoelectric element. The position adjustment mechanism 6 adjusts the position of the radiation image detector 4 based on a frequency component of moiré generated in an image for checking position shift detected by the radiation image detector 4 by preliminary irradiation, which will be described later. The method for adjusting the position will be described later in detail.

The radiation source 1 and a radiation source controller 34 are housed in the radiation source unit 15. The radiation source controller 34 controls the timing of emission of radiation from the radiation source 1 and radiation generation conditions (tube current, exposure time, tube voltage, and the like) at the radiation source 1.

Further, a compression paddle 18, a compression paddle support unit 20, and a compression paddle movement mechanism 19 are provided in the arm 13. The compression paddle 18 is arranged on the upper side of the radiography table 14, and the compression paddle 18 compresses a breast by pressing the breast onto the radiography table 14. The compression paddle support unit 20 supports the compression paddle 18, and the compression paddle movement mechanism 19 moves the compression paddle support unit 20 in a vertical direction (Z direction). The position of the compression paddle 18 and a pressure applied during compression are controlled by a compression paddle controller 36.

Here, the mammography and display system in the present embodiment performs radiography to obtain a phase contrast image of breast B by using the radiation source 1, the first grating 2, the second grating 3 and the radiation image detector 4. The structure of the radiation source 1, the first grating 2 and the second grating 3 necessary to perform radiography for obtaining the phase contrast image will be described more in detail. FIG. 2 is a diagram in which only the radiation source 1, the first grating 2, the second grating 3 and the radiation image detector 4 are extracted from FIG. 1. FIG. 3 is a schematic top view of the radiation source 1, the first grating 2, the second grating 3 and the radiation image detector 4 illustrated in FIG. 2.

The radiation source 1 emits radiation toward breast B. The radiation source 1 has sufficient spatial coherence to produce a Talbot interference effect when the first grating 2 is irradiated with radiation. For example, a radiation source, such as a microfocus X-ray tube and a plasma X-ray source, which has a small-size radiation emission point may be used as the radiation source 1. When a radiation source having a relatively large-size radiation emission point (so-called focal point size), as used in general medical practice, is used, the radiation source may be used by setting a multi-slit having a predetermined pitch on the radiation emission side of the radiation source. A detail structure of such a case is disclosed, for example, in Franz Pfeiffer, Timm Weikamp, Oliver Bunk, and Christian David, “Phase retrieval and differential phase-contrast imaging with low-brilliance X-ray sources”, Nature Physics, Vol. 2, pp. 258-261, 2006. It is necessary that pitch P₀ of the slit satisfies the following formula (1):

[FORMULA 1]

P₀=P₂×Z₀/Z₂ (1)

In the formula (1), P₂ is the pitch of the second grating 3. As illustrated in FIG. 3, Z₀ is a distance from multi-slit MS to the first grating 2. Further, Z₂ is a distance from the first grating 2 to the second grating 3.

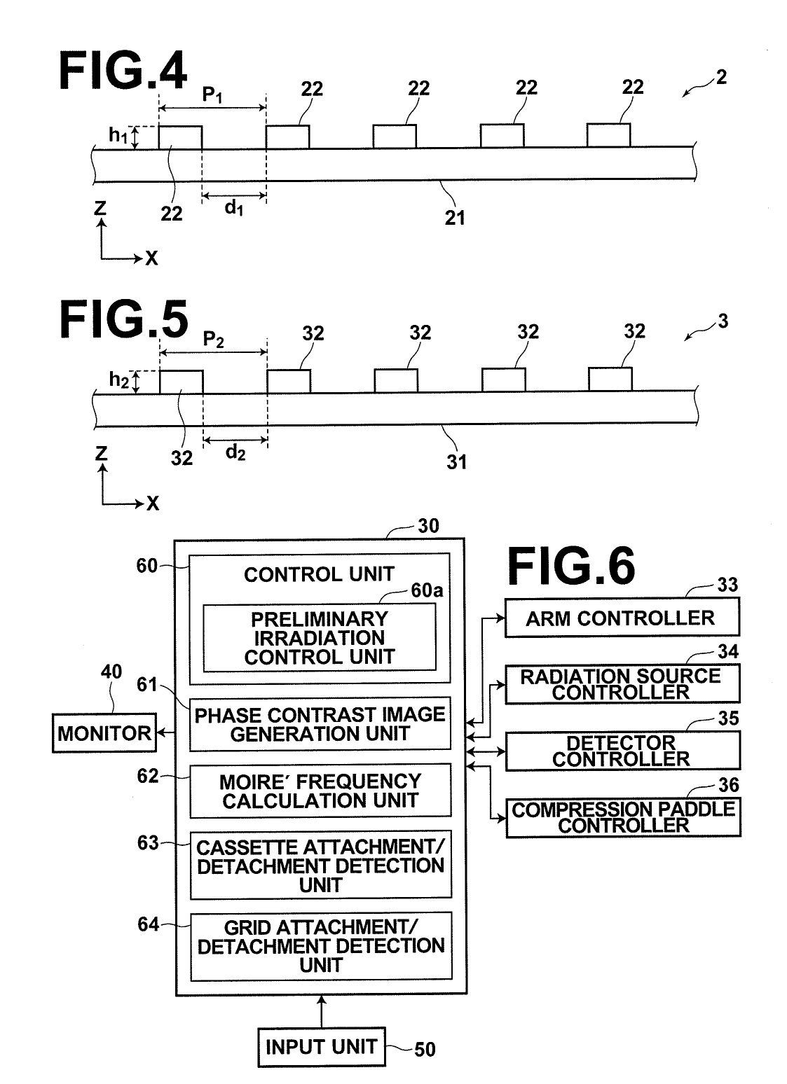

The first grating 2 passes radiation that has been output from the radiation source 1, and forms a first periodic pattern image (hereinafter, referred to as self image G1). As illustrated in FIG. 4, the first grating 2 includes a substrate 21 that mostly passes radiation and plural members 22 provided on the substrate 21. Each of the plural members 22 is a linear member extending in an in-plane direction (Y direction orthogonal to both X direction and Z direction, and which is the direction of the paper thickness in FIG. 4) orthogonal to the optical axis of radiation. The plural members 22 are arranged at constant cycle P₁ with predetermined interval d₁ therebetween in X direction. As the material of the members 22, metal, such as gold and platinum, may be used, for example. Further, it is desirable that the first grating 2 is a so-called phase-modulation-type grating that modulates the phase of radiation irradiating the first grating 2 by approximately 90° or by approximately 180°. For example, when the members 22 are made of gold, thickness h₁ of the member 22 required in an X-ray energy range for ordinary medical diagnosis is approximately in the range of 1 μm to 10 μm. Alternatively, an amplitude-modulation-type grating may be used. In this case, it is necessary that the member 22 has a sufficient thickness to absorb radiation. For example, when the members 22 are made of gold, thickness h₁ of the member 22 required in an X-ray energy range for typical medical diagnosis is approximately in the range of 10 μm to hundreds of μm.

The second grating 3 modulates the intensity of the first periodic pattern image formed by the first grating 2, and forms a second periodic pattern image. As illustrated in FIG. 5, the second grating 3 includes a substrate 31 that mostly passes radiation and plural members 32 provided on the substrate 31 in a manner similar to the first grating 2. The plural members 32 block radiation, and each of the plural members 32 is a linear member extending in an in-plane direction (Y direction orthogonal to both X direction and Z direction, and which is the direction of the paper thickness in FIG. 5) orthogonal to the optical axis of radiation. The plural members 32 are arranged at constant cycle P₂ with predetermined interval d₂ therebetween in X direction. As the material of the plural members 32, metal, such as gold and platinum, may be used, for example. It is desirable that the second grating 3 is an amplitude-modulation-type grating. In such a case, it is necessary that the member 32 has a sufficient thickness to absorb radiation. For example, when the members 32 are made of gold, thickness h₂ required in an X-ray energy range for typical medical diagnosis is approximately in the range of 10 μm to hundreds of μm.

Here, when radiation output from the radiation source 1 is not a parallel beam but a cone beam, self image G1 of the first grating 2 formed through the first grating 2 is magnified in proportion to a distance from the radiation source 1. Further, in the present embodiment, grating pitch P₂ and interval d₂ of the second grating 3 are determined in such a manner that slit portions of the second grating 3 substantially coincide with a periodic pattern of light parts of the self image G1 of the first grating 2 at the position of the second grating 3. Specifically, when a distance from the focal point of the radiation source 1 to the first grating 2 is Z₁, and a distance from the first grating 2 to the second grating 3 is Z₂, if the first grating 2 is a phase-modulation-type grating that modulates phase by 90° or an amplitude-modulation-type grating, grating pitch P₂ of the second grating 3 is determined so as to satisfy the following formula (2). Here, P₁′ is a pitch of the self image G1 of the first grating 2 at the position of the second grating 3.

$$\begin{matrix}[ FORMULA 2 ] & \\ {P}_{2} = {P}_{1}^{′} = \frac{{Z}_{1} + {Z}_{2}}{{Z}_{1}} {P}_{1} & ( 2 )\end{matrix}$$

If the first grating 2 is a phase-modulation-type grating that modulates phase by 180°, grating pitch P₂ of the second grating 3 is determined so as to satisfy the following formula (3):

$$\begin{matrix}[ FORMULA 3 ] & \\ {P}_{2} = {P}_{1}^{′} = \frac{{Z}_{1} + {Z}_{2}}{{Z}_{1}} \cdot \frac{{P}_{1}}{2} . & ( 3 )\end{matrix}$$

When radiation emitted from the radiation source 1 is a parallel beam, if the first grating 2 is a phase-modulation-type grating that modulates phase by 90° or an amplitude-modulation-type grating, the pitch P₂ of the second grating 3 is determined so as to satisfy P₂=P₁. If the first grating 2 is a phase-modulation-type grating that modulates phase by 180°, the pitch P₂ of the second grating 3 is determined so as to satisfy P₂=P₁/2.

Further, it is necessary that some other conditions are substantially satisfied to make the mammography apparatus 10 in the present embodiment function as a Talbot interferometer. Such conditions will be described.

First, it is necessary that the grid plane of the first grating 2 and the grid plane of the second grating 3 are parallel to X-Y plane illustrated in FIG. 2.

Further, when the first grating 2 is a phase-modulation-type grating that modulates phase by 90°, distance Z₂ between the first grating 2 and the second grating 3 must substantially satisfy the following condition:

$$\begin{matrix}[ FORMULA 4 ] & \\ {Z}_{2} = ( m + \frac{1}{2} ) \frac{{P}_{1} {P}_{2}}{λ} , & ( 4 )\end{matrix}$$

where λ is the wavelength of radiation (ordinarily, an effective wavelength), m is 0 or a positive integer, P₁ is a grating pitch of the first grating 2, as described above, and P₂ is a grating pitch of the second grating 3, as described above.

Further, when the first grating 2 is a phase-modulation-type grating that modulates phase by 180°, the following condition must be substantially satisfied:

$$\begin{matrix}[ FORMULA 5 ] & \\ {Z}_{2} = ( m + \frac{1}{2} ) \frac{{P}_{1} {P}_{2}}{2 λ} , & ( 5 )\end{matrix}$$

where λ is the wavelength of radiation (ordinarily, an effective wavelength), m is 0 or a positive integer, P₁ is a grating pitch of the first grating 2, as described above, and P₂ is a grating pitch of the second grating 3, as described above.

Alternatively, when the first grating 2 is an amplitude-modulation-type grating, the following condition must be substantially satisfied:

$$\begin{matrix}[ FORMULA 6 ] & \\ {Z}_{2} = {m}^{′} \frac{{P}_{1} {P}_{2}}{λ} , & ( 6 )\end{matrix}$$

where λ is the wavelength of radiation (ordinarily, an effective wavelength), m′ is a positive integer, P₁ is a grating pitch of the first grating 2, as described above, and P₂ is a grating pitch of the second grating 3, as described above.

The formulas (4), (5) and (6) are used when radiation emitted from the radiation source 1 is a cone beam. When the radiation emitted from the radiation source 1 is a parallel beam, the following formula (7) is used instead of the formula (4), and the following formula (8) is used instead of the formula (5), and the following formula (9) is used instead of the formula (6):

$$\begin{matrix}[ FORMULA 7 ] & \\ {Z}_{2} = ( m + \frac{1}{2} ) \frac{{P}_{1}^{2}}{λ} & ( 7 ) \\ [ FORMULA 8 ] & \\ {Z}_{2} = ( m + \frac{1}{2} ) \frac{{P}_{1}^{2}}{4 λ} & ( 8 ) \\ [ FORMULA 9 ] & \\ {Z}_{2} = {m}^{′} \frac{{P}_{1}^{2}}{λ} . & ( 9 )\end{matrix}$$

As illustrated in FIGS. 4 and 5, the thickness of the members 22 of the first grating 2 is h₁, and the thickness of the members 32 of the second grating 3 is h₂. When the thickness h₁ and the thickness h₂ are too thick, radiation that diagonally enters the first grating 2 and the second grating 3 tends not to pass through slit portions, and so-called vignetting occurs. Consequently, an effective field of view in a direction (X direction) orthogonal to the direction in which the members 22, 32 extend becomes narrow. Therefore, it is desirable to regulate the upper limits of the thicknesses h₁, h₂ to maintain a sufficient field of view. It is desirable that the thicknesses h₁, h₂ are set so as to satisfy the formulas (10) and (11) to maintain length V of the effective field of view in X direction on the detection surface of the radiation image detector 4. Here, L is a distance from the focal point of the radiation source 1 to the detection surface of the radiation image detector 4 (please refer to FIG. 3):

$$\begin{matrix}[ FORMULA 10 ] & \\ {h}_{1} \leq \frac{L}{V / 2} {d}_{1} & ( 10 ) \\ [ FORMULA 11 ] & \\ {h}_{2} \leq \frac{L}{V / 2} {d}_{2} . & ( 11 )\end{matrix}$$

Further, the scan mechanism 5 provided in the grid unit 16 translationally moves the second grating 3, as described above, in a direction (X direction) orthogonal to the extending direction of the members 32, in other words, the second grating 3 is moved in parallel. Accordingly, relative positions between the first grating 2 and the second grating 3 are changed. For example, the scan mechanism 5 is composed of an actuator, such as a piezoelectric element. Further, a second periodic pattern image formed by the second grating 3 at each position of the second grating 3 translationally moved by the scan mechanism 5 is detected by the radiation image detector 4.

FIG. 6 is a block diagram illustrating the configuration of the computer 30 illustrated in FIG. 1. The computer 30 includes a central processing unit (CPU), a storage device, such as a semiconductor memory, a hard disk and an SSD (solid-state drive or disk), and the like. Such hardware constitutes a control unit 60, a phase contrast image generation unit 61, a moiré frequency calculation unit 62, a cassette attachment/detachment detection unit 63, and a grid attachment/detachment detection unit 64, as illustrated in FIG. 6.

The control unit 60 outputs predetermined control signals to various controllers 33 through 36 to control the whole system.

Further, the control unit 60 includes a preliminary irradiation control unit 60a. The preliminary irradiation control unit 60a controls the radiation source 1, the radiation image detector 4 and the like based on the attachment/detachment detection conditions that have been detected by the cassette attachment/detachment detection unit 63 and the grid attachment/detachment detection unit 64, and performs preliminary irradiation. The preliminary irradiation is performed to obtain an image for checking position shift. The image for checking position shift is used to detect a relative positional deviation between the first and second gratings 2, 3 and the radiation image detector 4 caused by attachment or detachment of the grid unit 16 or the cassette unit 17. The method for controlling preliminary irradiation by the preliminary irradiation control unit 60a will be described later in detail.

The phase contrast image generation unit 61 generates a radiation phase contrast image based on image signals representing plural kinds of fringe images that are different from each other, and which have been detected by the radiation image detector 4 with respect to respective positions of the second grating 3. The method for generating the radiation phase contrast image will be described later in detail.

The moiré frequency calculation unit 62 obtains the image for checking position shift that has been detected by the radiation image detector 4 by preliminary irradiation. Further, the moiré frequency calculation unit 62 performs fast Fourier transformation on the image for checking position shift to obtain a frequency component of moiré generated in the image for checking position shift.

The frequency component of moiré calculated by the moiré frequency calculation unit 62 is output to the control unit 60. The control unit 60 calculates an adjustment amount of the position of the radiation image detector 4 that can make the input frequency component of moiré close to zero. Further, the control unit 60 outputs a control signal based on the adjustment amount of the position to the position adjustment mechanism 6 in the cassette unit 17.

The cassette attachment/detachment detection unit 63 detects attachment of the cassette unit 17 to the cassette support unit 17a and detachment therefrom. For example, the cassette attachment/detachment detection unit 63 may detect attachment/detachment of the cassette unit 17 by detecting electrical contact and non-contact. Alternatively, the cassette attachment/detachment detection unit 63 may detect attachment/detachment of the cassette unit 17 based on an output from an optical sensor or the like.

The grid attachment/detachment detection unit 64 detects attachment of the grid unit 16 to the grid support unit 16a and detachment therefrom. The grid attachment/detachment detection unit 64 may detect attachment/detachment of the grid unit 16 in a manner similar to the cassette attachment/detachment detection unit 63. For example, the grid attachment/detachment detection unit 64 may detect attachment/detachment of the grid unit 16 by detecting electrical contact and non-contact. Alternatively, the grid attachment/detachment detection unit 64 may detect attachment/detachment of the grid unit 16 based on an output from an optical sensor or the like.

The monitor 40 displays a phase contrast image generated by the phase contrast image generation unit 61 in the computer 30.

For example, the input unit 50 is composed of a keyboard and a pointing device, such as a mouse. The input unit 50 receives an input of a radiography condition, an instruction to start radiography, and the like by a radiographer (a user who performs radiography). Especially, in the present embodiment, an input of an instruction to start preliminary irradiation is received at the input unit 50.

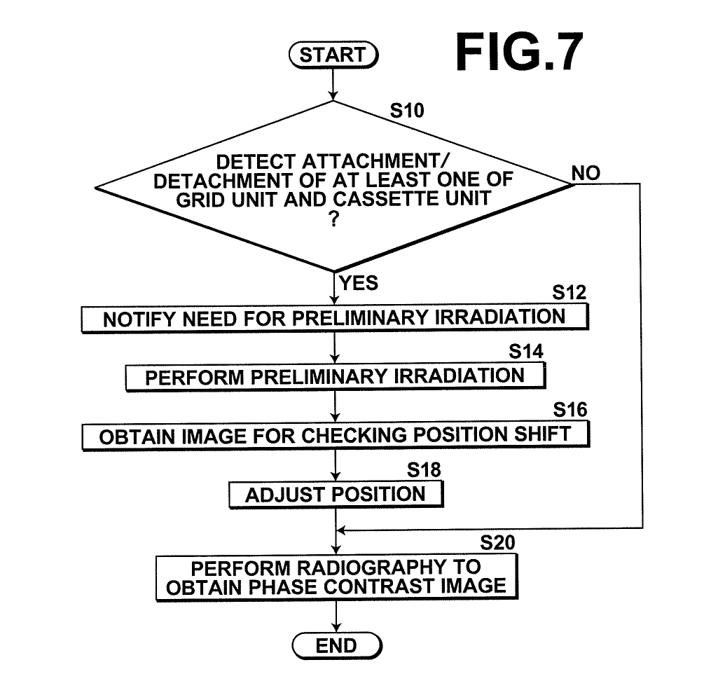

Next, the action of the mammography and display system in the present embodiment will be described with reference to a flow chart illustrated in FIG. 7.

First, the preliminary irradiation control unit 60a obtains information about whether the cassette unit 17 and the grid unit 16 are attached or detached in a period between the previous radiography operation for obtaining a phase contrast image and this radiography operation for obtaining a phase contrast image. The preliminary irradiation control unit 60a obtains the information from the cassette attachment/detachment detection unit 63 and the grid attachment/detachment detection unit 64 before this radiography operation.

When attachment/detachment of at least one of the cassette unit 17 and the grid unit 16 has been detected (step S10, YES), the preliminary irradiation control unit 60a makes the monitor 40 display a message notifying that preliminary irradiation for adjusting position is necessary (step S12). In the present embodiment, a message is displayed, but it is not necessary that the information is presented in such a manner. The radiographer may be notified by light of a lamp, or a sound.

When the radiographer notices the message displayed on the monitor 40, he/she inputs an instruction to start preliminary irradiation by using the input unit 50. The instruction to start preliminary irradiation received at the input unit 50 is input to the preliminary irradiation control unit 60a. The preliminary irradiation control unit 60a outputs control signals to the radiation source 1 and the radiation image detector 4 so that preliminary irradiation is performed.

Radiation is emitted from the radiation source 1, based on the control signal from the preliminary irradiation control unit 60a, without setting a subject in the apparatus. The radiation that has passed through the grid unit 16 irradiates the radiation image detector 4, and the radiation is detected as an image for checking position shift (step S14). At this time, it is assumed that the members 22 of the first grating 2 and the members 32 of the second grating 3 in the grid unit 16 are set parallel to each other. For example, if a relative positional deviation is generated between the first and second gratings 2, 3 in the grid unit 16 and the arrangement of pixels of the radiation image detector 4 in the cassette unit 17 after attachment/detachment, moiré is generated in the aforementioned image for checking position shift. For example, the moiré is generated when the pixel column or pixel row of the radiation image detector 4 is not parallel to grating members 22, 32 of the first and second gratings 2, 3, or when a relative positional relationship between the arrangement of pixels of the radiation image detector 4 and the members 22, 32 of the first and second gratings 2, 3 is shifted. The moiré will be described in detail.

Here, a distance from the radiation source 1 to the second grating is Z₁+Z₂, and the frequency (inverse number of cycle P₂) of the second grating 3 is f₁, and the frequency (inverse number of pixel pitch) of the pixel column of the radiation image detector 4 is f₂.

In radiography for obtaining the aforementioned image for checking position shift, a projection image is projected onto the radiation image detector 4 by radiation that has passed through the second grating 3, and the frequency of the projection image is as follows:

f₁′=f₁×(Z₁+Z₂)/(Z₁+Z₂+Z₃)

(please refer to FIG. 3).

Generally, the frequency of a moiré image formed by two frequency patterns, namely, frequency pattern f and frequency pattern g is |f±g|. Similarly, the frequency of a moiré image generated by the frequency of the first and second gratings 2, 3 and the frequency of pixel columns of the radiation image detector 4 is fm=|f₁′±f₂|. When the first and second gratings 2, 3 and the radiation image detector 4 are not shifted from each other, frequency fm of the moiré image is a value that is set in advance, and the moiré image does not substantially affect the phase contrast image. However, when the first and second gratins 2, 3 and the radiation image detector 4 are shifted from each other, a moiré image at frequency fm′, which is different from the aforementioned moiré image at frequency fm, is generated. This moiré image at frequency fm′ affects the phase contrast image.

Therefore, when the arrangement relationship between the first and second gratings 2, 3 and the radiation image detector 4 is adjusted in such a manner that the aforementioned frequency fm′ of the moiré image finally becomes close to the frequency fm, which has been set in advance, and more desirably, when the frequency fm′ becomes the same as the frequency fm, it is regarded that the arrangement relationship between the first and second gratings 2, 3 and the radiation image detector 4 is correctly adjusted.

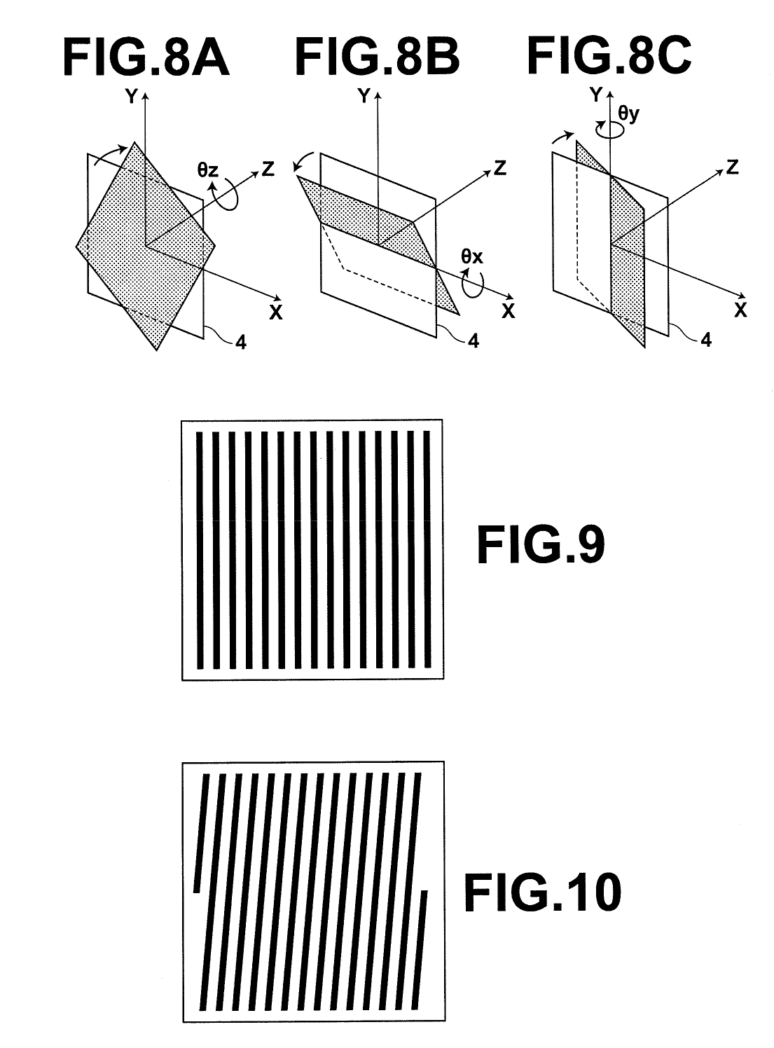

In the present embodiment, the radiation image detector 4 detects an image for checking position shift, and the arrangement of the radiation image detector 4 is adjusted by using the image for checking position shift. Meanwhile, a translational shift in position between the first and second gratings 2, 3 and the radiation image detector 4 in X direction or in Y direction does not affect the phase contrast image. Therefore, it is sufficient if the arrangement is substantially correct. In the present embodiment, position shift between the first and second gratings 2, 3 and the radiation image detector 4 in Z direction, rotation shift θz with respect to Z axis, as a rotation axis (illustrated in FIG. 8A), rotation shift θx with respect to X axis, as a rotation axis (illustrated in FIG. 8B), and rotation shift θy with respect to Y axis, as a rotation axis (illustrated in FIG. 8C) are adjusted.

Next, a moiré image at frequency fm′ included in the image for checking position shift will be described. Here, to simplify explanation, it is assumed that members, such as the radiation source 1 and the first and second gratings 2, 3, other than the radiation image detector 4, and which require positioning, are correctly arranged. Further, it is assumed that when the relative positional relationship between the first and second gratings 2, 3 and the radiation image detector 4 is not shifted, frequency fm of the moiré image is zero, or sufficiently low.

At this time, when the arrangement of the radiation image detector 4 is shifted, a moiré image is generated. For example, when position shift only in Z direction is present, a moiré image as illustrated in FIG. 9 is formed. Further, for example, when only rotation shift ez is present, a moiré image as illustrated in FIG. 10 is formed.

Further, the image for checking position shift including the moiré image is detected by the radiation image detector 4. The radiation image detector 4 outputs the image for checking position shift to the computer 30. The image for checking position shift is input to the moiré frequency calculation unit 62 in the computer 30 (step S16).

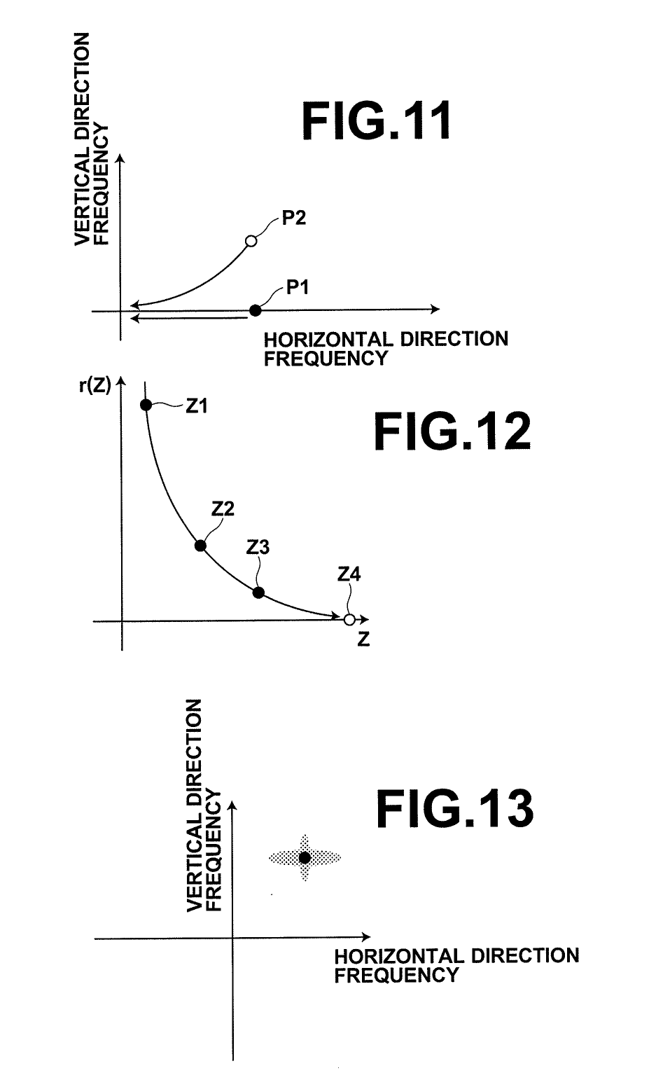

The moiré frequency calculation unit 62 performs fast Fourier transformation on the input image for checking position shift, and calculates the frequency component of the image for checking position shift in frequency space. Specifically, for example, when a moiré image is generated by position shift only in Z direction, as illustrated in FIG. 9, vertical-direction frequency is not present. Therefore, a peak frequency componentthat is present on the horizontal-direction frequency axis, as illustrated as black point P1 in FIG. 11, is calculated. Further, when a moiré image is generated only by rotation shift ez, as illustrated in FIG. 10, fringes are generated in a diagonal direction at a constant frequency. Therefore, a peak frequency component that has both of a horizontal-direction frequency component and a vertical-direction frequency component, as illustrated as white point P2 in FIG. 11, is calculated.

The peak frequency component calculated by the moiré frequency calculation unit 62 is output to the controller 60. The controller 60 calculates a relative inclination amount and a parallel shift amount between the radiation image detector 4 and the first and second gratings 2, 3 based on the distribution of the frequency component of the moiré in frequency space.

Specifically, for example, when position shift ΔZ only in Z direction is present, frequency component fm′ of the moiré image is calculated by using the following equation:

fm′=f₁×(Z₁+Z₂)/(Z₁+Z₂+Z₃+ΔZ)−f₂.

Therefore, arrangement shift amount ΔZ in Z direction is calculated by substituting the frequency component of the moiré image calculated by the moiré frequency calculation unit 62 for fm′. Further, the control unit 60 outputs a control signal based on the arrangement shift amount ΔZ to the position adjustment mechanism 6 of the cassette unit 17. Further, the position adjustment mechanism 6 adjusts the arrangement of the radiation image detector 4 based on the input arrangement shift amount ΔZ to a correct position (step S18). The adjustment by the position adjustment mechanism 6 can make the frequency of the moiré image close to frequency fm that has been set in advance, or more desirably, the frequency of the moiré image becomes the same as frequency fm.

Further, when only rotation shift θz is present, the control unit 60 calculates rotation shift amount θz based on the ratio of the vertical-direction frequency component to the horizontal-direction frequency component of the moiré image. Further, the radiation image detector 4 is rotated with respect to Z axis, as a rotation axis, based on the calculated rotation shift amount θz to adjust the position correctly. Here, the calculated rotation shift amount θz is an estimated value based on the premise that rotation shift amount θz of the first and second gratings 2, 3 is correct.

It is not necessary that the control unit 60 calculates the arrangement shift amount as described above. In short, any calculation method may be adopted as long as frequency component fm′ calculated by the moiré frequency calculation unit 62 becomes close to frequency fm that has been set in advance in frequency space. For example, function r(Z), as illustrated in FIG. 12, may be obtained. The function r (Z) is determined by a distance r from the origin in frequency space of a peak frequency component fm′ of a moiré image calculated by the moiré frequency calculation unit 62, and predetermined positions Z1, Z2, and Z3 in Z direction of the radiation image detector 4. The function r (Z) represents correlation among these positions. Further, position Z4 in Z direction, at which the value of the function r(Z) converges at zero, may be obtained to calculate the arrangement shift amount.

The frequency component of a moiré image by rotation shift θx and rotation shift θy is not illustrated. However, rotation shift θx and rotation shift θy are similar to continuous in-plane position shift in Z direction. Therefore, if rotation shift θx or rotation shift θy is present, a moiré frequency component is broadly distributed in frequency space, as illustrated in FIG. 13. Therefore, the arrangement of the radiation image detector 4 should be adjusted so that the distribution of the moiré frequency component becomes narrower.

In actual cases, a value representing the width of the distribution of the moiré frequency component is calculated, and the adjustment value of θx or θy should be determined in such a manner that the value converges at zero. As the value representing the width of the distribution of the moiré frequency component, for example, a width at half maximum of the peak frequency may be used. Further, the width of the distribution of the moiré frequency componentby rotation shift θx or θy reflects the maximum amplitude of position shift in Z direction caused by the rotation shift. Therefore, the adjustment amount may be calculated based on the width of the distribution of the moiré frequency component.

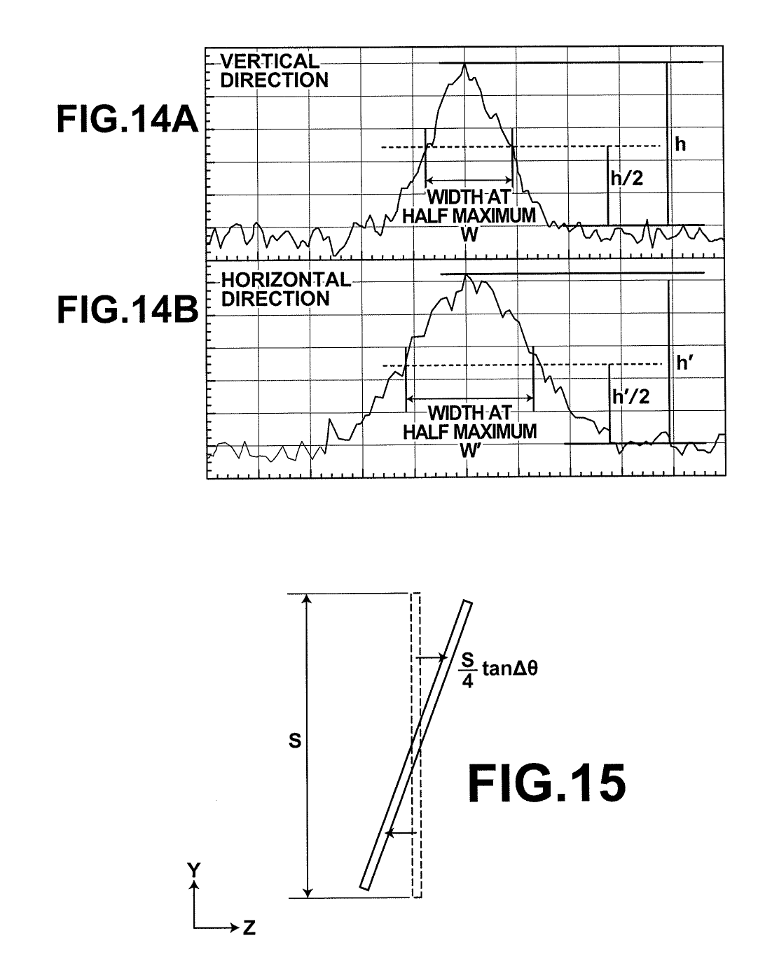

Specifically, for example, when the distribution of the moiré frequency component is as illustrated in FIG. 13, first, the peak frequency of the distribution of the moiré frequency component is detected. Further, a profile in the vicinity of the peak frequency is obtained for each of the vertical direction and the horizontal direction. FIG. 14A illustrates an example of a profile in vertical direction, and FIG. 14B illustrates an example of a profile in horizontal direction. Further, width W at half maximum of the profile in the vertical direction, and width W′ at half maximum of the profile in the horizontal direction are obtained.

Here, for example, when angle shift Δθ is present with respect to θx, arrangement shift of approximately ΔZ=±S/4·tan Δθ in Z direction is present in a central area of the radiation image detector 4, as illustrated in FIG. 15.

Further, as described above, when the frequency fm that has been set in advance is zero, or sufficiently low, moiré frequency is calculated by the following formula:

fm′=f₁×(Z₁+Z₂)/(Z₁+Z₂+Z)−f₂.

Therefore, the width of the moiré frequency fm′ corresponds to width W at half maximum. Specifically, in the above equation, when ΔZ=±S/4·tan Δθ, the amplitude of the moiré frequency fm′ corresponds to width W at half maximum. Therefore, it is possible to obtain Δθ by using the following equation:

∥f₁×(Z₁+Z₂)/(Z₁+Z₂+Z₃+S/4·tan Δθ)−f₂|−|f₁×(Z₁+Z₂)/(Z₁+Z₂+Z₃−S/4·tan Δθ)−f₂∥=W

In the above descriptions, a method for calculating angle shift Δθ of θx has been described. When angle shift Δθ′ of θy is calculated, the apparent frequency of pixel columns of the radiation image detector 4 varies with respect to θy, which is different from the above case. Therefore, f₂ in the equation of moiré frequency fm′ is replaced by f₂ tan θ. Further, a width of the moiré frequency fm′ is regarded as a value corresponding to width W′ at half maximum, and the angle shift Δθ′ of θy should be calculated.

In the above descriptions, a shift amount of θx and a shift amount of θy were calculated. However, it is not necessary that a shift amount of θx and a shift amount of θy are calculated. For example, a variation of width W at half maximum with respect to a change of θx may be obtained while θx is changed by the position adjustment mechanism 6. Further, θx when width W at half maximum becomes zero or a minimum value may be set as a correct position. Further, with respect to θy, a variation of width W′ at half maximum with respect to a change of θy may be obtained while θy is changed by the position adjustment mechanism 6. Further, θy when width W′ at half maximum becomes zero or a minimum value may be set as a correct position.

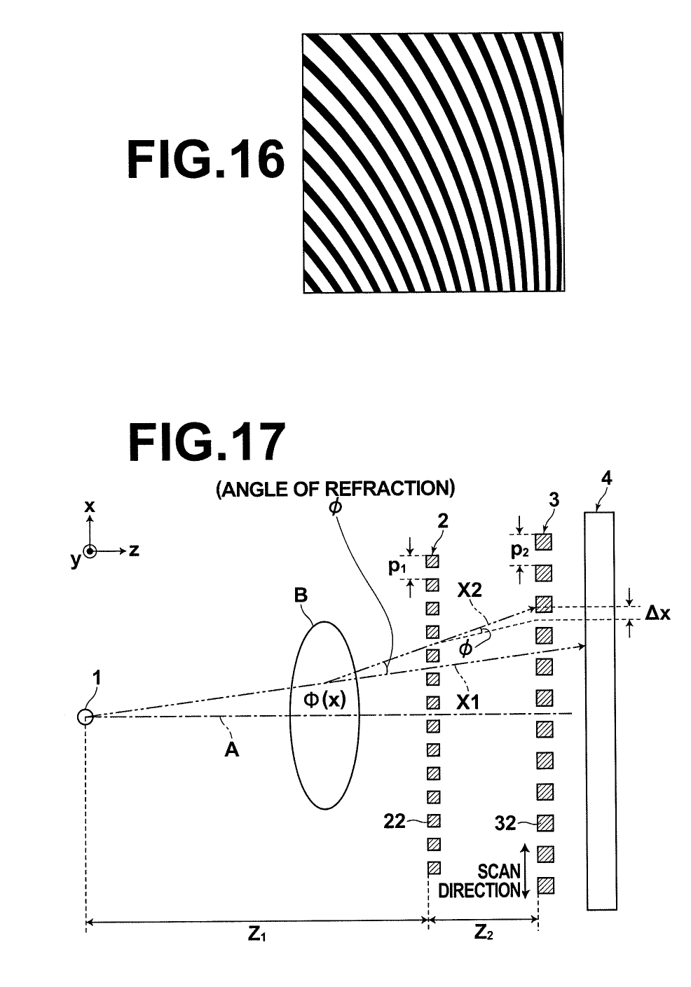

Further, when rotation shift of θx or θy is present, a distorted moiré image, which is not uniform in a plane as illustrated in FIG. 16, is generated. In this manner, the rotation shift of θx or θy is observed, as a distortion of the moiré image, in an actual image. Further, the rotation shift of θx or θy appears as a spread of the moiré frequency component in frequency space. Therefore, it is difficult to directly adjust the position shift in Z direction and rotation shift of θz. Therefore, first, a value representing the width of the distribution of the moiré frequency component, as described above, is calculated, and θx or θy is adjusted so that the value representing the width of the distribution of the moiré frequency component converges at zero. Accordingly, the moiré image becomes uniform in the plane. After then, position shift in Z direction and rotation shift of θz should be adjusted.

Further, in the descriptions of the present embodiment, the arrangement shift amount was calculated based on the frequency component of a moiré image, and the arrangement of the radiation image detector 4 was automatically adjusted, based on the arrangement shift amount, by the position adjustment mechanism 6. However, it is not necessary that the arrangement is adjusted in such a manner. For example, a frequency chart with the frequency component of the moiré image may be displayed on a predetermined display unit, or the numerical value of the frequency component of the moiré image may be displayed on the display unit. Further, a radiographer (operator) may manually adjust the position of the radiation image detector 4 so that the frequency component of the moiré image becomes close to frequency fm that has been set in advance, or more desirably the frequency component of the moiré image becomes the same as frequency fm, while observing the chart or the numerical value displayed on the display unit.

After the position of the radiation image detector 4 is adjusted, as described above, radiography for obtaining a phase contrast image is started (step S20). In step S10, if neither attachment/detachment of the grid unit 16 nor attachment/detachment of the cassette unit 17 has been detected (step S10, NO), radiography for obtaining a phase contrast image is started without adjusting the position of the radiation image detector 4.

Specifically, breast B of a patient is set on the radiography table 14, and the breast B is compressed onto the radiography table 14 at predetermined pressure by the compression paddle 18.

Next, the radiographer inputs an instruction to start radiography for obtaining a phase contrast image at the input unit 50. Further, radiation is emitted from the radiation source 1 based on the input of the instruction to start radiography.

Radiation that has passed through the breast B irradiates the first grating 2. The radiation that has irradiated the first grating is diffracted by the first grating 2, and forms a Talbot interference image at a predetermined distance from the first grating 2 in the direction of the optical axis of the radiation.

This effect is called as a Talbot effect. When a radiation wave-front has passed through the first grating 2, self image G1 of the first grating 2 is formed at a position away from the first grating 2 by a predetermined distance. For example, when the first grating 2 is a phase-modulation-type grating that modulates phase by 90°, self image G1 of the first grating 2 is formed at a distance given by the formula (4) or (7) (when a phase-modulation-type grating that modulates phase by 180° is used, a distance given by the formula (5) or (8), and when an intensity-modulation-type grating is used, a distance given by the formula (6) or (9)). Since the wavefront of radiation entering the first grating 2 is distorted by the breast B, which is a subject to be examined, the self image G1 of the first grating 2 is deformed based on the distortion.

Then, the radiation passes through the second grating 3. Consequently, the deformed self image G1 of the first grating 2 is superimposed on the second grating 3, and the intensity of the deformed self image is modulated. The deformed self image is detected by the radiation image detector 4, as image signals reflecting the distortion of the wavefront. The image signals detected by the radiation image detector 4 are input to the phase contrast image generation unit 61 in the computer 30.

Next, a method for generating a phase contrast image at the phase contrast image generation unit 61 will be described. First, the principle of the method for generating a phase contrast image in the present embodiment will be described.

FIG. 17 is a diagram illustrating a path of a ray of radiation refracted based on phase shift distribution Φ(x) related to X direction of subject B to be examined. In FIG. 17, sign X1 indicates a path of radiation when subject B to be examined is not present, and the radiation travels straight. The radiation traveling through the path X1 passes through the first grating 2 and the second grating 3, and is incident on the radiation image detector 4. Sign X2 indicates a path of radiation when the subject B to be examined is present, and the radiation has been refracted by the subject B to be examined and deflected. The radiation traveling through the path X2 passes through the first grating 2, and is blocked by the second grating 3.

The phase shift distribution Φ(x) of the subject B to be examined is represented by the following formula (12) when the distribution of refractive index of the subject B to be examined is n (x, z), and the direction in which radiation travels is z. Here, y coordinate is omitted to simplify explanation.

$$\begin{matrix}[ FORMULA 12 ] & \\ Φ ( x ) = \frac{2 π}{λ} {\int }_{ }^{ } [ 1 - n ( x , z ) ] d z . & ( 12 )\end{matrix}$$

Self image G1 of the first grating 2 formed at the position of the second grating 3 is shifted (displaced) by refraction of radiation by the subject B to be examined. The self image G1 is shifted, in X direction, by an amount corresponding to angle φ of refraction of radiation. Position shift amount Δx is approximated by the following formula (13) based on the premise that the angle φ of refraction of radiation is minute:

[FORMULA 13]

Δx≈Z₂φ (13)

Here, the angle φ of refraction is represented by the following formula (14) by using wavelength λ of radiation and phase shift distribution Φ(x) of subject B to be examined:

$$\begin{matrix}[ FORMULA 14 ] & \\ ϕ = \frac{λ}{2 π} \frac{\partial Φ ( x )}{\partial x} . & ( 14 )\end{matrix}$$

As described above, position shift amount Δx of self image G1 by refraction of radiation by the subject B to be examined is related to phase shift distribution Φ(x) of the subject B to be examined. Further, the position shift amount Δx is related to phase shift amount Ψ of an intensity-modulated signal of each pixel detected by the radiation image detector 4 (a phase shift amount of an intensity-modulated signal of each pixel between a case with subject B to be examined and a case without the subject m), as represented in the following formula (15):

$$\begin{matrix}[ FORMULA 15 ] & \\ ψ = \frac{2 π}{{P}_{2}} Δ x = \frac{2 π}{{P}_{2}} {Z}_{2} ϕ . & ( 15 )\end{matrix}$$

Therefore, it is possible to obtain angle φ of refraction by obtaining phase shift amount Ψ of the intensity-modulated signal of each pixel by the formula (15). Further, the differential value of phase shift distribution Φ(x) is obtainable by using the formula (14). Further, it is possible to obtain phase shift distribution Φ(x) of the subject B to be examined by integrating the differential value with respect to x. In other words, it is possible to generate a phase contrast image of the subject B to be examined. In the present embodiment, the phase shift amount Ψis calculated by a fringe scan method as described below.

In the fringe scan method, image acquisition operation as described above is performed while one of the first grating 2 and the second grating 3 is translationally moved, in X-direction, relative to the other one of the first grating 2 and the second grating 3. In the present embodiment, the second grating 3 is moved by the aforementioned scan mechanism 5. As the second grating 3 moves, a fringe image detected by the radiation image detector 4 moves. When the distance of the translational motion (a movement amount in X direction) reaches one arrangement cycle (arrangement pitch P₂) of the second grating 3, in other words, when a change in phase between the self image G1 of the first grating 2 and the second grating 3 reaches 2π, the fringe image returns to the original position. Such a change in the fringe image is detected by the radiation image detector 4 while the second grating 3 is moved, step by step, by a distance of a P₂ divided by an integer. Accordingly, the fringe images are detected at the radiation image detector 4. Further, the intensity-modulated signal of each pixel is obtained from the detected plural fringe images, and phase shift amount Ψ of the intensity-modulated signal of each pixel is obtained.

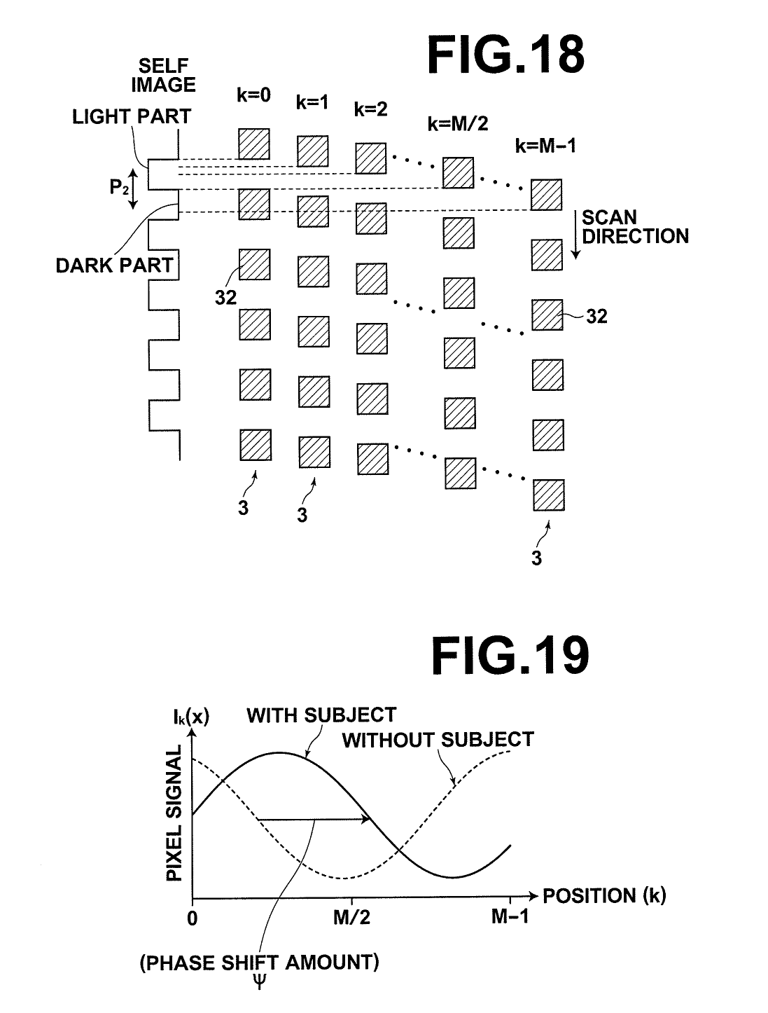

FIG. 18 is a schematic diagram illustrating the manner of moving the second grating 3, step by step, by a movement pitch (P₂/M) which is obtained by dividing arrangement pitch P₂ by M (integer greater than or equal to 2). The scan mechanism 5 translationally moves the second grating 3 to each of M positions (k=0, 1, 2, . . . , M−1) in this order. In FIG. 17, a position (k=0) at which a dark part of the self image G1 of the first grating 2 when subject B to be examined is not present substantially coincides, at the position of the second grating 3, with the member 32 of the second grating 3 is regarded as an initial position of the second grating 3. However, any position k=0, 1, 2, . . . , M−1 may be regarded as the initial position.

First, at the position of k=0, radiation that has not been refracted by the subject B to be examined mainly passes through the second grating 3. As the second grating 3 is moved to k=1, 2, . . . in this order, in radiation that passes through the second grating 3, a component of radiation that has not been refracted by the subject B to be examined decreases, and a component of radiation that has been refracted by the subject B to be examined increases. Especially, when k=M/2, only the component of radiation that has been refracted by the subject B to be examined mainly passes through the second grating 3. However, when k exceeds M/2, in radiation that passes through the second grating 3, a component of the radiation refracted by the subject B to be examined decreases, and a component of the radiation that has not been refracted by the subject B to be examined increases.

Further, M fringe image signals (M is the number of images), representing M fringe images, are obtained by performing image acquisition at each position of k=0, 1, 2, . . . , M−1 by the radiation image detector 4. The obtained fringe image signals are stored in the phase contrast image generation unit 61.

Next, a method for calculating phase shift amount Ψ of the intensity-modulated signal of each pixel based on the pixel signal of each pixel of the M fringe image signals will be described.

First, pixel signal Ik(x) of each pixel at position k of the second grating 3 is represented by the following formula (16):

$$\begin{matrix}[ FORMULA 16 ] & \\ {I}_{k} ( x ) = {A}_{0} + {\sum }_{n > 0}^{ } {A}_{n} exp [ 2 πi \frac{n}{{P}_{2}} \{ {Z}_{2} ϕ ( x ) + \frac{{kP}_{2}}{M} \} ] . & ( 16 )\end{matrix}$$

Here, x represents the coordinate of a pixel related to x direction, and A₀ represents the intensity of incident radiation. Aₙ is a value corresponding to the contrast of the intensity-modulated signal (here, n is a positive integer). Further, φ(x) is the angle φ of refraction represented as a function of coordinate x of a pixel of the radiation image detector 4.

Next, when a relational equation represented by the following formula (17) is used, the angle φ(x) of refraction is represented as in formula (18):

$$\begin{matrix}[ FORMULA 17 ] & \\ {\sum }_{k = 0}^{M - 1} exp ( - 2 πi \frac{k}{M} ) = 0 & ( 17 ) \\ [ FORMULA 18 ] & \\ ϕ ( x ) = \frac{{p}_{2}}{2 π {Z}_{2}} arg [ {\sum }_{k = 0}^{M - 1} {I}_{k} ( x ) exp ( - 2 πi \frac{k}{M} ) ] . & ( 18 )\end{matrix}$$

Here, “arg[ ]” means extraction of an argument, which corresponds to phase shift amount Ψ of each pixel of the radiation image detector 4. Therefore, it is possible to obtain angle φ(x) of refraction by calculating, based on the formula (18), the phase shift amount ΨY of the intensity-modulated signal of each pixel from the pixel signals of the M fringe image signals obtained for each pixel of the radiation image detector 4.

Specifically, as illustrated in FIG. 19, M fringe image signals obtained for each pixel of the radiation image detector 4 periodically change with respect to position k of the second grating 3. In FIG. 19, a broken line indicates a pixel signal variation when subject B to be examined is not present, and a solid line indicates a pixel signal variation when subject B to be examined is present. A phase difference between the waveforms of the two lines corresponds to phase shift amount Ψ of the intensity-modulated signals of each pixel.

The angle Ψ (x) of refraction corresponds to the differential value of phase shift distribution Φ(x), as represented by the formula (14). Therefore, it is possible to obtain phase shift distribution Φ(x) by integrating the angle φ(x) of refraction along x axis.

In the above descriptions, y coordinate of the pixel related to y direction was not considered. However, it is possible to obtain two-dimensional distribution φ(x,y) of the angle of refraction by performing a similar operation also for each y coordinate. Further, it is possible to obtain two-dimensional phase shift distribution Φ(x, y), as a phase contrast image, by integrating the two-dimensional distribution φ(x,y) along x axis.

Alternatively, the phase contrast image may be generated by integrating two-dimensional distribution Ψ(x,y) of the phase shift amount along x axis, instead of the two-dimensional distribution φ(x,y) of the angle of refraction.

Since the two-dimensional distribution φ(x,y) of the angle of refraction and the two-dimensional distribution Ψ(x,y) of the phase shift amount correspond to the differential value of phase shift distribution Φ(x,y), they are called as differential phase images. The differential phase images may be generated as phase contrast images.

As described above, the phase contrast image generation unit 61 generates a phase contrast image based on plural fringe images.

The phase contrast image generated by the phase contrast image generation unit 61 is output to the monitor 40, and displayed.

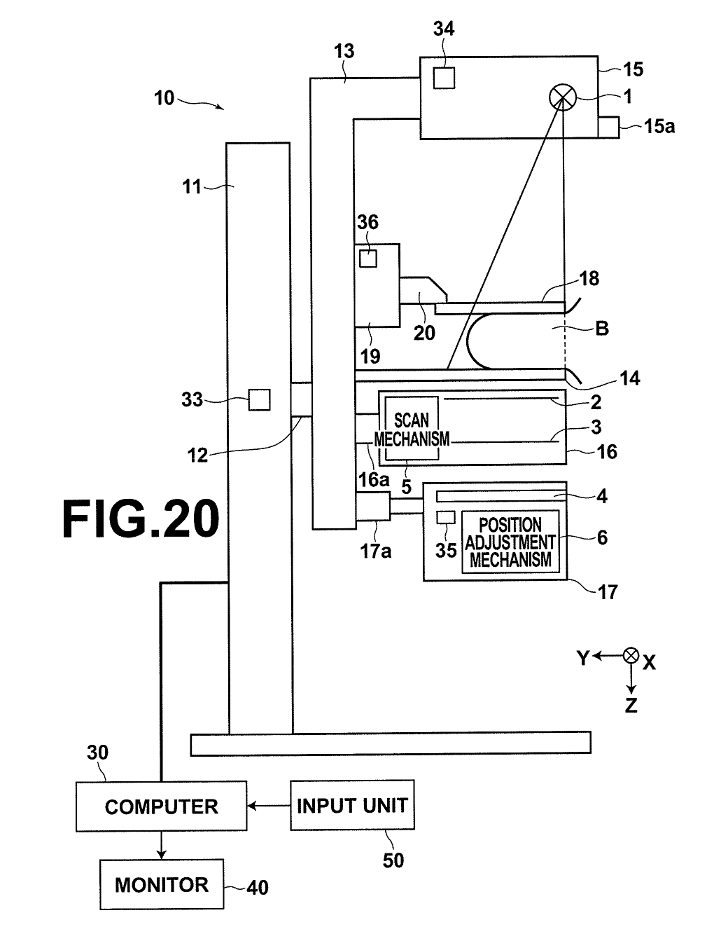

In the above embodiment, when the cassette unit 17 or the grid unit 16 has been attached or detached, information that preliminary irradiation is necessary is displayed on the monitor 40. After the information is displayed, preliminary irradiation is performed by an instruction by the radiographer. However, it is not necessary that preliminary irradiation is performed in such a manner. For example, as illustrated in FIG. 20, a person detection unit 15a may be provided for the radiation source unit 15. The person detection unit 15a detects whether there is no person at least in the irradiation range of radiation (presence of a person in the range). Preliminary irradiation may be automatically performed when the person detection unit 15a has detected that there is no person at least in the irradiation range of radiation.

As the person detection unit 15a, a camera for photographing at least the irradiation range of radiation, or the like may be used for example. However, it is not necessary that such a camera is used. Alternatively, a sensor, such as an infrared ray sensor, may be used.

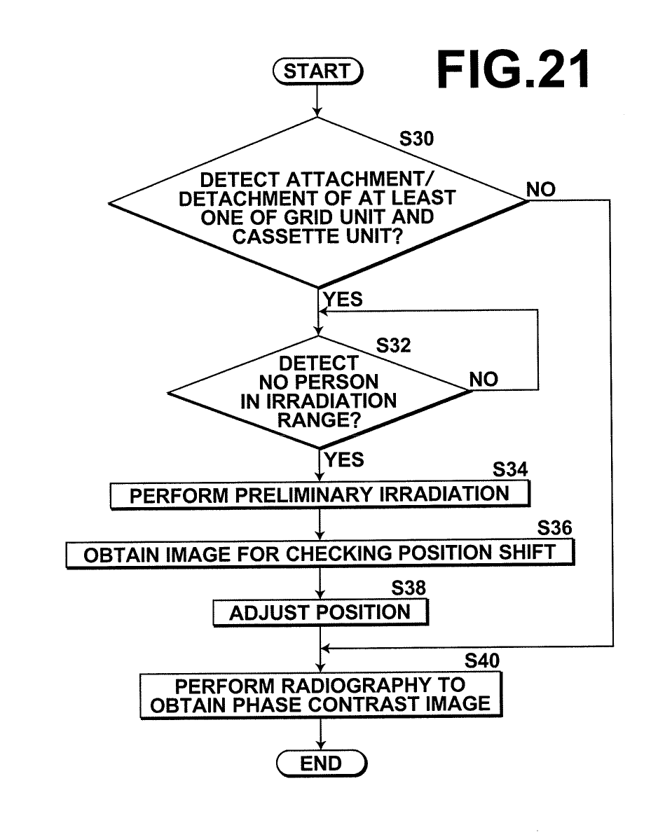

When the aforementioned person detection unit 15a is provided, the action of preliminary irradiation in the mammography and display system is performed as in the flow chart of FIG. 21.

Specifically, the preliminary irradiation control unit 60a obtains information about whether the cassette unit 17 has been attached or detached during a period between the previous radiography for obtaining a phase contrast image and the present radiography for obtaining a phase contrast image, and information about whether the grid unit 16 has been attached or detached during a period between the previous radiography for obtaining a phase contrast image and the present radiography for obtaining a phase contrast image in a manner similar to the above embodiment. The preliminary irradiation control unit 60a obtains such information from the cassette attachment/detachment detection unit 63 and the grid attachment/detachment detection unit 64 before this radiography operation.

When attachment or detachment of at least one of the cassette unit 17 and the grid unit 16 has been detected (step S30, YES), the preliminary irradiation control unit 60a checks whether the person detection unit 15a has detected that no person is present at least in the irradiation range of radiation.

When the preliminary irradiation control unit 60a has found that there is no person in the irradiation range (step S32, YES), the preliminary irradiation control unit 60a outputs a control signal to the radiation source 1 and the radiation image detector 4 so that preliminary irradiation is performed. When the state that no person is in the irradiation range is not being detected by the person detection unit 15a, someone may be in the irradiation range of radiation. Therefore, preliminary irradiation is not performed (step S32, NO).

Steps S34 through S40 after preliminary irradiation are similar to steps S14 through S20 in FIG. 7.

In the above embodiment, the position of the radiation image detector 4 is adjusted based on a moiré image of the image for checking position shift. Alternatively, the positions of the first and second gratings 2, 3 may be adjusted instead of the radiation image detector 4.

In the above embodiment, both of the radiation image detector 4 and the first and second gratings 2, 3 are attachable and detachable. Alternatively, only one of the radiation image detector 4 and the first and second gratings 2, 3 may be attachable and detachable.

The radiation phase contrast imaging apparatus in the aforementioned embodiment is structured in such a manner that distance Z₂ from the first grating 2 to the second grating 3 becomes a Talbot interference distance. However, it is not necessary that the radiation phase contrast imaging apparatus is structured in such a manner. Alternatively, the radiation phase contrast imaging apparatus may be structured in such a manner that the first grating 2 projects incident radiation without diffracting the radiation. When the radiation phase contrast imaging apparatus is structured in such a manner, similar projection images of radiation projected through the first grating 2 are obtainable at all positions on the rear side of the first grating 2. Therefore, it is possible to set the distance Z₂ from the first grating 2 to the second grating 3 without regard to the Talbot interference distance.

Specifically, both the first grating 2 and the second grating 3 are structured as absorption-type (amplitude modulation type) gratings. Further, the apparatus is structured in such a manner that radiation that has passed through a slit portion is geometrically projected without regard to a Talbot interference effect. More specifically, it is possible to structure the apparatus so that most of radiation emitted from the radiation source 1 is not diffracted by the slit portions by setting, as interval d₁ of the first grating 2 and interval d₂ of the second grating 3, values sufficiently larger than the effective wavelength of radiation emitted from the radiation source 1. For example, in the case of the radiation source with a tungsten target, the effective wavelength of radiation is approximately 0.4 Å at a tube voltage 50 kV. In this case, most of radiation is not diffracted by the slit portions, and the radiation is geometrically projected when the interval d₁ of the first grating 2 and the interval d₂ of the second grating 3 are approximately in the range of 1 μm to 10 μm.

With respect to the relationship between grating pitch P₁ of the first grating 2 and grating pitch P₂ of the second grating 3, the apparatus is structured in a similar manner to the first embodiment.

In the radiation phase contrast imaging apparatus structured as described above, distance Z₂ between the first grating 2 and the second grating 3 may be set shorter than a minimum Talbot interference distance when m′=1 in the formula (6). Specifically, the distance Z₂ is set so as to satisfy the range represented by the following formula (19):

$$\begin{matrix}[ FORMULA 19 ] & \\ {Z}_{2} < \frac{{P}_{1} {P}_{2}}{λ} . & ( 19 )\end{matrix}$$

It is desirable that the members 22 of the first grating 2 and the members 32 of the second grating 3 completely block (absorb) radiation to generate a high-contrast periodic pattern image. However, even if a material (gold, platinum or the like) with high absorption property for radiation is used, no small amount of radiation passes through the gratings without being absorbed.

Therefore, it is desirable that thicknesses h₁, h₂ of the members 22, 32 are as thick as possible to increase the radiation blocking capability of the members 22, 32. It is desirable that the members 22, 32 block at least 90% of radiation that has irradiated the members 22, 32. For example, when the tube voltage of the radiation source 1 is 50 kV, it is desirable that the thicknesses h₁, h₂ are greater than or equal to 100 μm in gold (Au) equivalent.

However, a problem of so-called vignetting of radiation exists in a manner similar to the aforementioned embodiment. Therefore, it is desirable to regulate the thickness h₁, h₂ of the members 22 of the first grating 2 and the members 32 of the second grating 3.

In the radiation phase contrast imaging apparatus structured as described above, it is possible to make distance Z₂ between the first grating 2 and the second grating 3 shorter than a Talbot interference difference. Therefore, it is possible to further reduce the thickness of the radiographic apparatus, compared with the radiographic apparatus in the aforementioned embodiment that needs to maintain a certain Talbot interference distance.

In the aforementioned embodiment, the second grating 3 is translationally moved by the scan mechanism 5 in the grid unit 16, and radiography is performed plural times to obtain plural fringe image signals for generating a phase contrast image. However, it is not necessary that the second grating 3 is translationally moved. Plural fringe image signals may be obtained by performing only one image acquisition operation.

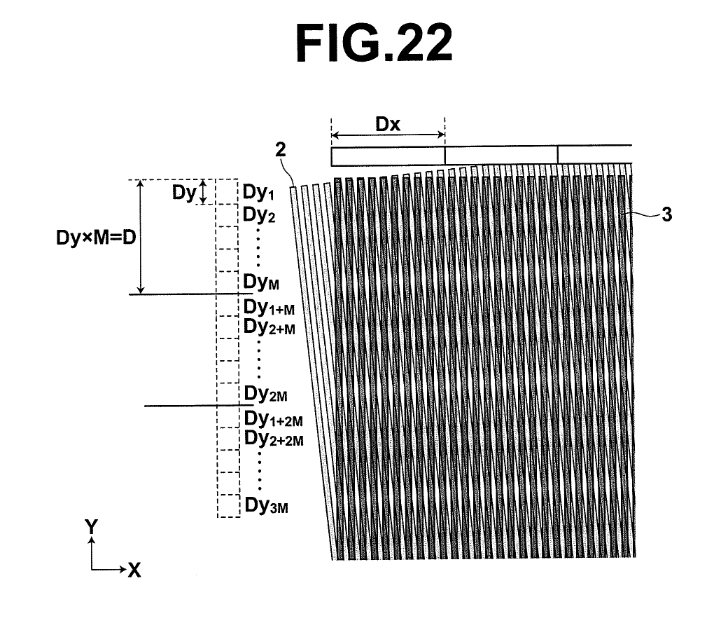

Specifically, as illustrated in FIG. 22, the first grating 2 and the second grating 3 are arranged in such a manner that a direction in which the self image G1 of the first grating 2 extends and a direction in which the second grating 3 extends incline relative to each other. With respect to the first grating 2 and the second grating 3 arranged in such a manner, the relationship between main pixel size Dx in a main scan direction (X direction in FIG. 22) and sub pixel size Dy in a sub scan direction of each pixel of an image signal detected by the radiation image detector 4 is as illustrated in FIG. 22.

For example, when a radiation image detector using a so-called optical readout method is used, the main pixel size Dx is determined by the arrangement pitch of linear electrodes of the radiation image detector. The radiation image detector using the so-called optical readout method includes many linear electrodes, and the radiation image detector is scanned by a linear readout light source that extends in a direction orthogonal to a direction in which the linear electrodes extend. Accordingly, image signals are readout. Further, the sub pixel size Dy is determined by the width of linear readout light irradiated to the radiation image detector in a direction where the linear electrodes extend. Further, when a radiation image detector using a so-called TFT readout method or a radiation image detector using a CMOS (complementary metal-oxide semiconductor) sensor is used, the main pixel size Dx is determined by the arrangement pitch of pixel circuits in the arrangement direction of data electrodes from which image signals are read out. The sub pixel size Dy is determined by the arrangement pitch of pixel circuits in the arrangement direction of gate electrodes from which gate voltage is output.

Further, when the number of fringe images for generating a phase contrast image is M, the self image G1 of the first grating 2 is inclined relative to the second grating 3 in such a manner that M sub pixel sizes Dy (Dy×M) becomes one image resolution D in the sub scan direction of the phase contrast image.

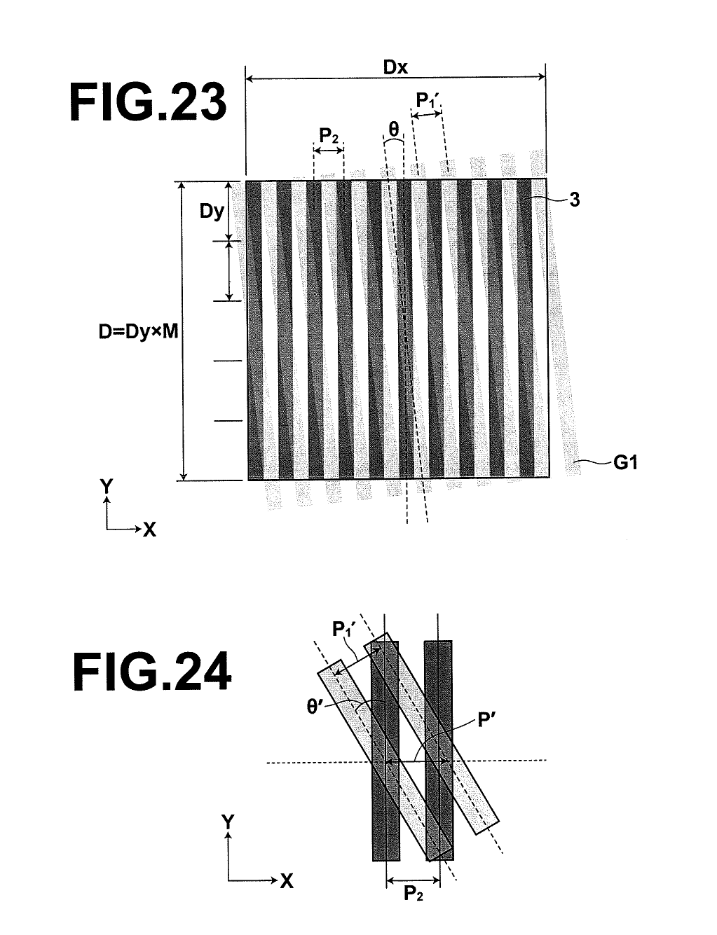

Specifically, as illustrated in FIG. 23, when the pitch of the second grating 3 and the pitch of self image G1 of the first grating 2 formed by the first grating 2 at the position of the second grating 3 are P₁′, and a relative rotation angle of the self image G1 of the first grating 2 with respect to the second grating 3 in X-Y plane is θ, and an image resolution of a phase contrast image in a sub scan direction is D (=Dy×M), if the rotation angle θ is set so as to satisfy the following formula (20), the phase of the self image G1 of the first grating 2 deviates from that of the second grating 3 by n cycle (s) over the length of the image resolution D in the sub scan direction. FIG. 23 illustrates a case in which M=5, and n=1.

$$\begin{matrix}[ FORMULA 20 ] & \\ θ = arc tan \{ n \times \frac{{P}_{1}^{′}}{D} \} \\ where n is an integer excluding 0 and multiples of M . & ( 20 )\end{matrix}$$

Therefore, each pixel of Dx×Dy, obtained by dividing image resolution D in the sub scan direction of the phase contrast image by M, can detect an image signal obtainable by dividing an intensity-modulated self image G1 of the first grating 2 for n cycle (n is the number of cycles) by M. In the example illustrated in FIG. 23, n=1. Therefore, the phase of self image G1 of the first grating 2 deviates from that of the second grating 3 by one cycle over the length of the image resolution D in the sub scan direction. In simpler words, an area of the self image G1 of the first grating 2 for one cycle, the area passing through the second grating 3, varies over the length of the image resolution D in the sub scan direction. Accordingly, the intensity of the self image G1 of the first grating 2 is modulated in the sub scan direction.

Further since M=5, each pixel of Dx×Dy can detect an image signal obtainable by dividing intensity-modulated self image of the first grating 2 for one cycle by 5. In other words, pixels of Dx×Dy can detect image signals of 5 fringe images that are different from each other, respectively.

In the present embodiment, Dx=50 μm, Dy=10 μm, and M=5, as described above. Therefore, the image resolution Dx in the main scan direction of the phase contrast image and the image resolution D=Dy×M in the sub scan direction are the same. However, it is not necessary that the image resolution Dx in the main scan direction and the image resolution D in the sub scan direction are the same, and they may have an arbitrary ratio between the main scan direction and the sub scan direction.

In the present embodiment, M=5. However, it is not necessary that the value of M is 5 as long as the value of M is greater than or equal to 3. In the above descriptions, n=1. However, it is not necessary that the value of n is 1 as long as the value of n is an integer other than 0. Specifically, when the value of n is a negative integer, the direction of rotation is opposite to the direction in the aforementioned example. Further, n may be an integer other than ±1, and the intensity modulation may be performed for n cycles. However, a case in which the value of n is a multiple of M should be excluded, because the phase of the self image G1 of the first grating 2 and the phase of the second grating 3 become the same among a set of M sub scan direction pixels Dy, and different M fringe images are not formed.

Further, rotation angle θ of the self image G1 of the first grating 2 with respect to the second grating 3 may be adjusted, for example, by rotating the first grating 2 after the relative rotation angle between the radiation image detector 4 and the second grating 3 is fixed.

For example, when P₁′=5 μm, D=50 μm, and n=1 in the formula (20), rotation angle θ is approximately 5.7°. Further, actual rotation angle θ′ of the self image G1 of the first grating 2 with respect to the second grating 3 may be detected, for example, based on the pitch of a moiré pattern formed by the self image G1 of the first grating 2 and the second grating 3.

Specifically, as illustrated in FIG. 24, when the actual rotation angle is θ′, and an apparent pitch of self image G1 in X direction generated by rotation is P′, pitch Pm of observed moiré is as follows:

1/Pm=|1/P′−1/P₁|.

Therefore, when P′=P₁′/cos θ′ is substituted for P′ in the above equation, it is possible to obtain the actual rotation angle θ′. Further, the pitch Pm of the moiré should be obtained based on image signals detected by the radiation image detector 4.

Further, the rotation angle θ to be set, obtained by the formula (20), and the actual rotation angle θ′ should be compared with each other, and the rotation angle of the first grating 2 should be corrected automatically or manually by the difference between the rotation angle θ to be set and the actual rotation angle θ′.

Further, in the radiation phase contrast imaging apparatus structured as described above, after image signals for a whole one frame are read out from the radiation image detector 4, and stored in the phase contrast image generation unit 61, image signals representing 5 fringe images that are different from each other are obtained based on the stored image signals.

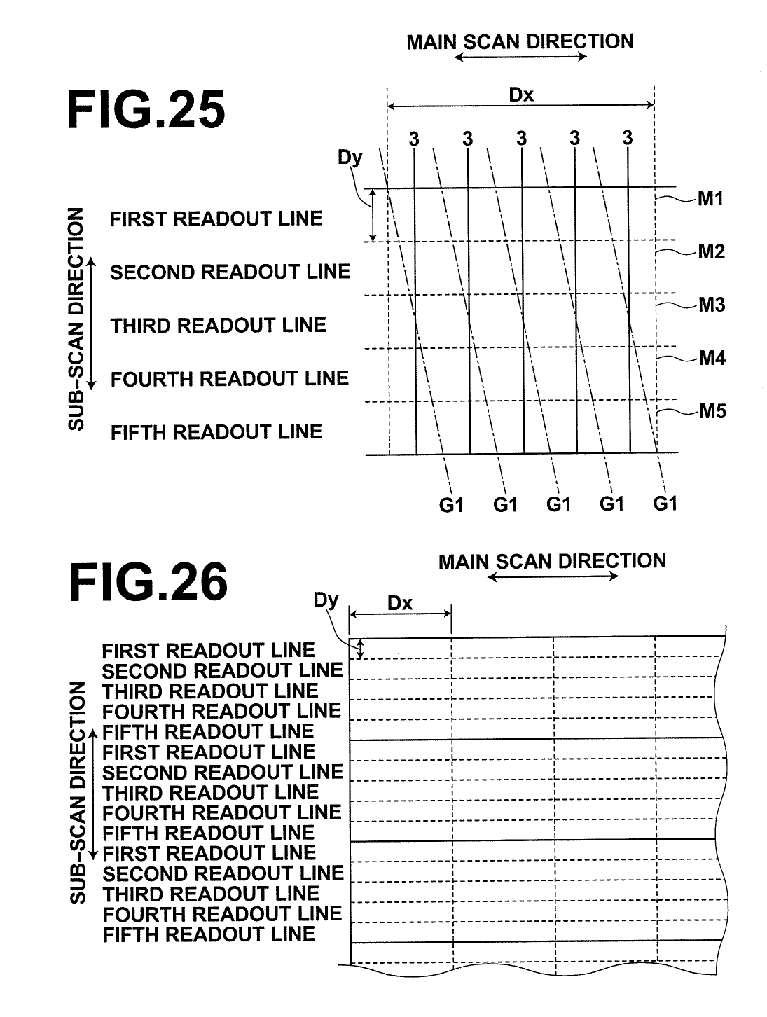

Specifically, as illustrated in FIG. 22, image resolution D in sub scan direction of the phase contrast image is divided by 5, and self image G1 of the first grating 2 is inclined relative to the second grating 3 so that image signals obtainable by dividing intensity-modulated self image G1 of the first grating 2 for a cycle by 5 are detectable. In such a case, as illustrated in FIG. 25, an image signal read out from a first readout line is obtained as first fringe image signal M1, an image signal read out from a second readout line is obtained as second fringe image signal M2, an image signal read out from a third readout line is obtained as third fringe image signal M3, an image signal read out from a fourth readout line is obtained as fourth fringe image signal M4, and an image signal read out from a fifth readout line is obtained as fifth fringe image signal M5. The each width in the sub scan direction of first through fifth readout lines illustrated in FIG. 25 corresponds to sub pixel size Dy illustrated in FIG. 22.

In FIG. 25, only a readout range of Dx×(Dy×5) is illustrated. However, the first through fifth fringe image signals are obtained also in other readout ranges in a similar manner. Specifically, as illustrated in FIG. 26, image signals representing a group of pixel rows (readout lines) with 4 pixel intervals between pixel rows in the sub scan direction are obtained, as a frame of one-fringe-image signal. More specifically, image signals of a group of pixel rows of first readout lines are obtained, as a frame of first fringe image signals. Image signals of a group of pixel rows of second readout lines are obtained, as a frame of second fringe image signals. Image signals of a group of pixel rows of third readout lines are obtained, as a frame of third fringe image signals. Image signals of a group of pixel rows of fourth readout lines are obtained, as a frame of fourth fringe image signals. Image signals of a group of pixel rows of fifth readout lines are obtained, as a frame of fifth fringe image signals.

Here, a case in which the image resolution D is divided by 5 has been described. When the image resolution D is divided by M, each of a series of Dy₁, Dy_{1+M}, Dy_{1+2M}, DY_{1+3M} . . . , a series of Dy₂, DY_{2+M}, DY_{2+2M, Dy}_{2+3M} . . . , a series of Dy₃, Dy_{3+M}, Dy_{3+2M}, Dy_{3+3M} . . . , and the like, as illustrated in FIG. 22, is obtained as a frame of fringe image signals.

Further, the phase contrast image generation unit 61 generates a phase contrast image based on the first through fifth fringe image signals.

Next, a method for adjusting a relative position shift between the first and second gratings 2, 3 and the radiation image detector 4 in the aforementioned embodiment, in which plural fringe image signals are obtained in one image acquisition operation, will be described.

First, the action until the preliminary irradiation control unit 60a performs preliminary irradiation to obtain the image for checking position shift is similar to the above embodiment.

The image for checking position shift detected by the radiation image detector 4 is input to the moiré frequency calculation unit 62. The moiré frequency calculation unit 62 groups Dy in every M pixel in sub scan direction into the same series of Dy in a manner similar to obtainment of plural fringe image signals by the phase contrast image generation unit 61. The series of Dy are, for example, a series of Dy₁, Dy_{1+M}, Dy_{1+2M}, Dy_{1+3M}, . . . , and a series of Dy₂, Dy_{2+M}, Dy_{2+2M}, Dy_{2+3M}, . . . , as illustrated in FIG. 22. In other words, sub pixel D is regarded as one unit, and Dy located at the same (corresponding) position in each unit of sub pixel D is grouped into the same series. Further, fast Fourier transformation is performed on at least one of the series to calculate the frequency component of the moiré image in the image for checking position shift. Further, distribution of the frequency component in the frequency space is obtained. Further, the frequency component of the moiré image may be obtained for each of plural series to more accurately calculate position shift.

The action after calculating the frequency component of the moiré image in the image for checking position shift is similar to the above embodiment.

In the above descriptions, as illustrated in FIG. 22, an image obtained while the direction in which the self image G1 of the first grating 2 extends and the direction in which the second grating 3 extends incline relative to each other is used. Further, plural fringe image signals are obtained by obtaining image signals of groups of pixel rows, and the groups being different from each other, from the single image. Further, a phase contrast image is generated by using the plural fringe image signals. However, instead of generating the plural fringe image signals based on the single image, as described above, a phase contrast image may be generated also by performing Fourier transformation on the single image obtained by image acquisition as described above. Such a method may be adopted.

Specifically, first, Fourier transformation is performed on an image obtained while a direction in which the self image G1 of the first grating 2 extends and a direction in which the second grating 3 extends incline relative to each other. By performing Fourier transformation on the image, absorption information and phase information by subject B to be examined included in the image are separated.

Then, only the phase information by the subject B to be examined is extracted in frequency space, and moved to a center position (origin) in the frequency space. After then, inverse Fourier transformation is performed on the extracted phase information to obtain a result. Further, the imaginary part of the result is divided by the real part of the result, and arc tangent function of the division result (arctan (imaginary part/real part)) is calculated with respect to each pixel. Accordingly, it is possible to obtain angle φ of refraction in the formula (18). Further, it is possible to obtain the differential value of phase shift distribution in the formula (14). In other words, it is possible to obtain a differential phase image.

In the aforementioned method for generating a phase contrast image using Fourier transformation, a single image obtained while the direction in which the self image G1 of the first grating 2 extends and the direction in which the second grating 3 extends incline relative to each other is used. However, it is not necessary that such an image is used. Moiré may be generated by placing the self image G1 of the first grating 2 on the second grating 3, and at least an image (fringe image) in which the moiré is detected may be used.

When Fourier transformation is performed on at least one fringe image to obtain a differential phase image, as described above, it is also desirable that the position of the radiation image detector 4 or the positions of the first and second gratings 2, 3 are adjusted so that moiré frequency fm′ in the image for checking position shift becomes close to moiré frequency fm that has been set in advance.

Further, in the radiation phase contrast imaging apparatus in the aforementioned embodiment, two gratings, namely, the first grating 2 and the second grating 3 are used. However, it is possible to omit the second grating 3 by providing the function of the second grating 3 in a radiation image detector. Next, the structure of a radiation image detector having the function of the second grating 3 will be described.

In the radiation image detector having the function of the second grating 3, self image G1 of the first grating 2 formed by the first grating 2 by passing radiation through the first grating 2 is detected. Further, charge signals corresponding to the self image G1 are stored in a charge storage layer divided in grid form, which will be described later. Accordingly, the intensity of the self image G1 is modulated, and a fringe image is generated. The generated fringe image is output as an image signal.

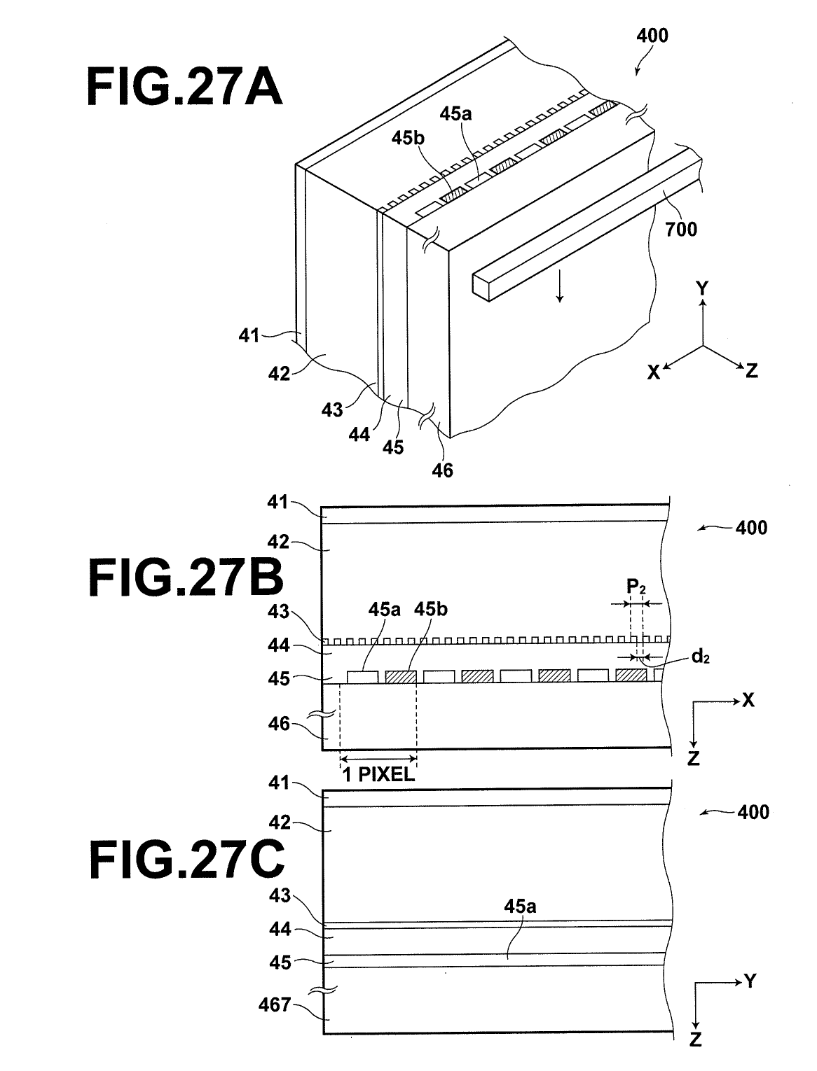

FIG. 27A is a perspective view of a radiation image detector 400 having a function of the second grating 3. FIG. 27B is an XY-plane cross section of the radiation image detector 400 illustrated in FIG. 27A. FIG. 27C is a YZ-plane cross section of the radiation image detector 400 illustrated in FIG. 27A.

As illustrated in FIG. 27A through 27C, the radiation image detector 400 includes a first electrode layer 41, a photoconductive layer 42 for recording, a charge storage layer 43, a photoconductive layer 44 for readout, and a second electrode layer 45, which are placed one on another in this order. The first electrode layer 41 passes radiation, and the photoconductive layer 42 for recording generates charges by irradiation with radiation that has passed through the first electrode layer 41. The charge storage layer 43 acts as an insulator for charges of one of the polarities of the charges generated in the photoconductive layer 42 for recording, and acts as a conductor for charges of the opposite polarity. Further, the photoconductive layer 44 for readout generates charges by illumination with readout light. These layers are formed on a glass substrate 46 in the mentioned order with the second electrode layer 45 at the bottom.

The first electrode layer 41 should pass radiation. For example, NESA coating (SnO₂), ITO (Indium Tin Oxide), IZO (Indium Zinc Oxide), IDIXO (Idemitsu Indium X-metal Oxide; Idemitsu Kosan, Co., Ltd.), which is an amorphous light-transmissive oxide coating, or the like may be formed in a thickness of 50 to 200 nm, as the first electrode layer 41. Alternatively, Al, Au, or the like with a thickness of 100 nm or the like may be used as the first electrode layer 41.

The photoconductive layer 42 for recording should generate charges by irradiation with radiation. A material containing a-Se, as a main component, may be used, because a-Se has a relatively high quantum efficiency with respect to radiation, and dark resistance is high. An appropriate thickness of the photoconductive layer 42 for recording is greater than or equal to 10 μm and less than or equal to 1500 pm. Especially, when the apparatus is used for mammography, it is desirable that the thickness of the photoconductive layer 42 for recording is greater than or equal to 150 pm and less than or equal to 250 μm. For general radiography use, it is desirable that the thickness of the photoconductive layer 42 for recording is greater than or equal to 500 pm and less than or equal to 1200 pm.

The charge storage layer 43 should have insulation properties with respect to charges having a polarity to be stored. The charge storage layer 43 may be made of polymers, such as an acryl-based organic resin, polyimide, BCB, PVA, acryl, polyethylene, polycarbonate and polyetherimide, sulfides, such as As₂S₃, Sb₂S₃ and ZnS, oxides, fluorides or the like. Further, it is more desirable that the charge storage layer 43 has insulation properties with respect to charges having a polarity to be stored, but conduction properties with respect to charges of the opposite polarity. Further, it is desirable to use a substance in which the product of mobility by lifetime differs at least by three digits between the polarities of charges.

Examples of an appropriate compound for the charge storage layer 43 are As₂Se₃, a compound obtained by doping As₂Se₃ with Cl, Br, or I in the range of 500 ppm to 20000 ppm, As₂(SeₓTe₁₋ₓ)₃ (0.5<x<1), which is obtained by substituting Se in As₂Se₃ with Te up to approximately 50%, a compound obtained by substituting Se in As₂Se₃ with S up to approximately 50%, AsₓSe_{y} (x+y=100, 34≦x≦46), which is obtained by changing the As concentration of As₂Se₃ by approximately ±15%, an amorphous Se—Te-based compound containing Te at 5 to 30 wt %, and the like.

It is desirable that the dielectric constant of the material of the charge storage layer 43 is greater than or equal to a half of the dielectric constants of the photoconductive layer 42 for recording and the photoconductive layer 44 for readout, and less than or equal to twice the dielectric constants of the photoconductive layer 42 for recording and the photoconductive layer 44 for readout so that an electric line of force formed between the first electrode layer 41 and the second electrode layer 45 does not curve.

Further, as illustrated in FIGS. 27A through 27C, the charge storage layer 43 is divided in linear form parallel to a direction in which transparent linear electrodes 45a and light-blocking linear electrodes 45b in the second electrode layer 45 extend.

The charge storage layer 43 is divided with a pitch narrower than the arrangement pitch of the transparent linear electrodes 45a or the light-blocking linear electrodes 45b. Arrangement pitch P₂ and interval d₂ of the charge storage layer 43 are similar to the conditions of the second grating 3 in the aforementioned embodiment.

Further, the thickness of the charge storage layer 43 is less than or equal to 2 um in a direction in which the layer is deposited (Z direction).

For example, the charge storage layer 43 may be formed by resistance heating vapor deposition by using the aforementioned materials and a metal mask or a mask formed by fibers or the like. The metal mask which is a metal plate with well-aligned apertures. Alternatively, the charge storage layer 43 may be formed by photolithography.

The photoconductive layer 44 for readout should exhibit conductivity by receiving readout light. For example, a photoconductive material containing, as a main component, at least one of a-Se, Se—Te, Se—As—Te, non-metal phthalocyanine, metal phthalocyanine, MgPc (Magnesium phtalocyanine), VoPc (phase II of Vanadyl phthalocyanine), CuPc (Copper phtalocyanine), and the like is appropriate. It is desirable that the thickness of the photoconductive layer 44 for readout is approximately 5 to 20 pm.

The second electrode layer 45 includes plural transparent linear electrodes 45a, which pass readout light, and plural opaque linear electrodes 45b, which block the readout light. The transparent linear electrodes 45a and the opaque linear electrodes 45b continuously extend in straight line form from an edge of an image formation area of the radiation image detector 400 to the opposite edge of the image formation area. As illustrated in FIGS. 27A and 27B, the transparent linear electrodes 45a and the opaque linear electrodes 45b are alternately arranged with a predetermined space therebetween.

The transparent linear electrodes 45a are made of a material that passes readout light and that has conductivity. For example, in a manner similar to the first electrode layer 41, ITO, IZO or IDIXO may be used. Further, the thickness of the transparent linear electrodes 45a is approximately 100 to 200 nm.

The opaque linear electrodes 45b are made of a material that blocks readout light and that has conductivity. For example, the aforementioned transparent conductive material and a color filter may be used in combination. The thickness of the transparent conductive material is approximately 100 to 200 nm.

As described later in detail, an image signal is read out at the radiation image detector 400 by using a pair of a transparent linear electrode 45a and a opaque linear electrode 45b arranged next to each other. Specifically, as illustrated in FIG. 27B, a pair of a transparent linear electrode 45a and a opaque linear electrode 45b is used to read out an image signal for a pixel. For example, the transparent linear electrodes 45a and the opaque linear electrodes 45b may be arranged so that a pixel is approximately 50 pm.

Further, as illustrated in FIG. 27A, a linear readout light source 700 that extends in a direction (X direction) orthogonal to a direction in which the transparent linear electrodes 45a and the opaque linear electrodes 45b extend is provided. The linear readout light source 700 includes a light source, such as an LED (Light Emitting Diode) or an LD (Laser Diode), and a predetermined optical system. The linear readout light source 700 is structured in such a manner to emit linear readout light with a width of approximately 10 pm to the radiation image detector 400 with respect to a direction (Y direction) in which the transparent linear electrodes 45a and the light-blocking linear electrodes 45b extend. The linear readout light source 700 is moved in Y direction by a predetermined movement mechanism (not illustrated). By this movement of the linear readout light source 700, the radiation image detector 400 is scanned with linear readout light emitted from the linear readout light source 700, and image signals are read out.

With respect to a distance between the first grating 2 and the radiation image detector 400 for functioning as a Talbot interferometer, conditions are similar to those of the distance between the first grating 2 and the second grating 3, because the radiation image detector 400 functions as the second grating 3.

Next, the action of the radiation image detector 400 structured as described above will be described.

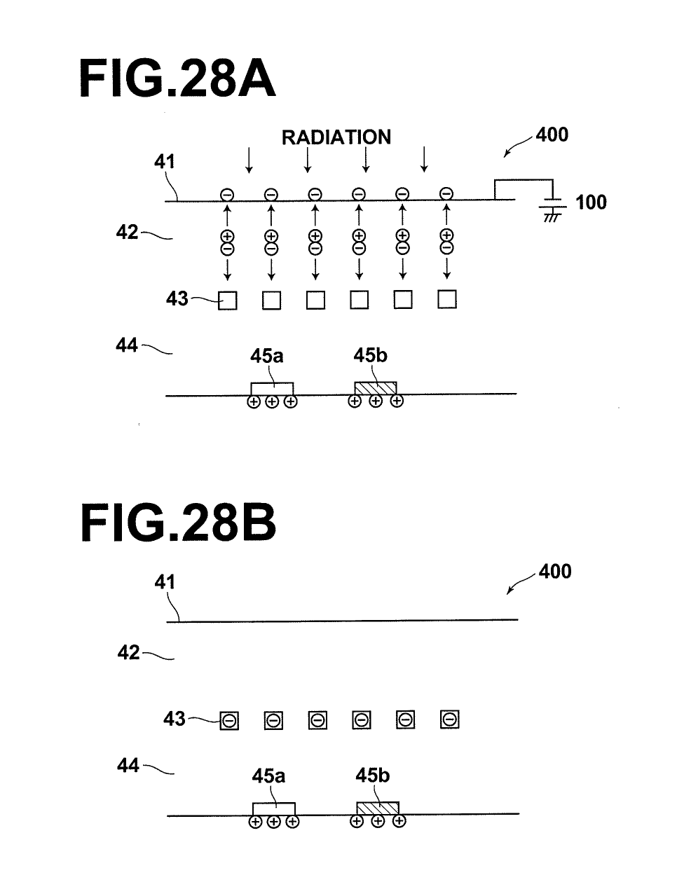

First, as illustrated in FIG. 28A, while negative voltage is applied to the first electrode layer 41 of the radiation image detector 400 by a high voltage source 100, radiation carrying self image G1 of the first grating 2 formed by a Talbot effect irradiates the radiation image detector 400 from the first electrode layer 41 side thereof.

The radiation that has irradiated the radiation image detector 400 passes through the first electrode layer 41, and irradiates the photoconductive layer 42 for recording. An electron-hole pair is generated in the photoconductive layer 42 for recording by irradiation with the radiation. A positive charge of the charge pair is combined with a negative charge in the first electrode layer 41, and disappears. A negative charge of the charge pair is stored in the charge storage layer 43 as a latent image charge (please refer to FIG. 28B).

Here, the charge storage layer 43 is divided in linear form with an arrangement pitch as described above. Therefore, among charges that have been generated based on the self image G1 of the first grating 2 in the photoconductive layer 42 for recording, only charges with the charge storage layer 43 present just under the charges are trapped by the charge storage layer 43, and stored. Other charges pass through space (hereinafter, referred to as a non-charge-storage area) between linear patterns of the linear charge storage layer 43, and pass through the photoconductive layer for readout. The charges that have passed through the photoconductive layer 44 for readout flow out to the transparent linear electrodes 45a and the opaque linear electrodes 45b.

As described above, among charges generated in the photoconductive layer 42 for recording, only charges with the linear charge storage layer 43 present just under the charges are stored in the charge storage layer 43. By this action, the intensity of the self image G1 of the first grating 2 is modulated by overlapping with the linear patterns of the charge storage layer 43. Further, image signals of a fringe image reflecting a distortion of the wavefront of self image G1 by subject B to be examined are stored in the charge storage layer 43. In other words, the charge storage layer 43 achieves a function similar to the second grating 3 in the aforementioned embodiment.

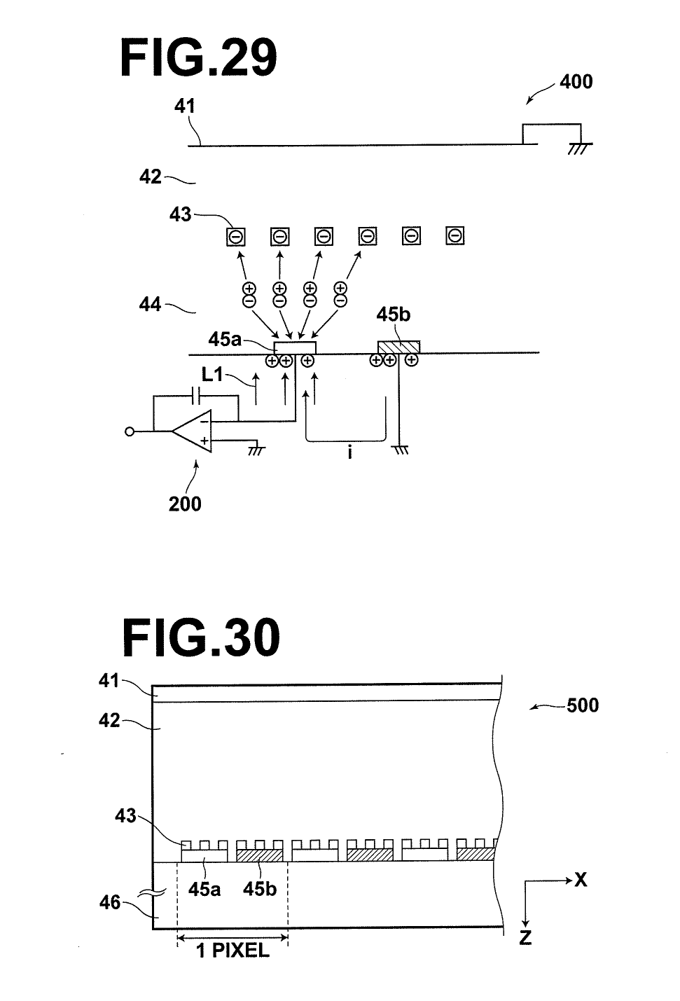

Next, as illustrated in FIG. 29, while the first electrode layer 41 is grounded, linear readout light L1 output from the linear readout light source 700 illuminates the radiation image detector 400 from the second electrode layer 45 side. The readout light L1 passes through the transparent linear electrodes 45a, and illuminates the photoconductive layer 44 for readout. Positive charges generated in the photoconductive layer 44 for readout by illumination with the readout light L1 are combined with latent image charges in the charge storage layer 43. Further, negative charges generated in the photoconductive layer 44 for readout by illumination with the readout light L1 are combined with positive charges in the light-blocking linear electrodes 45b through a charge amplifier 200 connected to the transparent linear electrodes 45a.

Since the negative charges generated in the photoconductive layer 44 for readout and the positive charges in the opaque linear electrodes 45b are combined with each other, an electric current flows to the charge amplifier 200. The electric current is integrated, and detected as image signals.

Further, the linear readout light source 700 moves in a sub scan direction (Y direction), and the radiation image detector 400 is scanned with the linear readout light L1. Further, image signals are sequentially detected for each readout line illuminated with the linear readout light L1 by the aforementioned action. The detected image signal for each readout line is sequentially input to the phase contrast image generation unit 61, and stored.

Further, the entire area of the radiation image detector 400 is scanned with readout light L1, and image signals for a whole one frame are stored in the phase contrast image generation unit 61.

In the radiation phase contrast imaging apparatus in the aforementioned embodiment, the second grating 3 is translationally moved with respect to the first grating 2. In a similar manner, plural fringe images are obtainable by translationally moving the radiation image detector 400 having the aforementioned function of the second grating 3 with respect to the first grating 2.

Further, the phase contrast image generation unit 61 generates a phase contrast image based on 5 fringe image signals.

In the radiation image detector 400 that has a function of the second grating 3 as described above, three layers of the photoconductive layer 42 for recording, the charge storage layer 43 and the photoconductive layer 44 for readout are provided between the electrodes. However, it is not necessary that the layers are structured in such a manner. For example, as illustrated in FIG. 30, the linear charge storage layer 43 may be provided directly on the transparent linear electrodes 45a and the opaquelinear electrodes 45b of the second electrode layer without providing the photoconductive layer 44 for readout. Further, the photoconductive layer 42 for recording may be provided on the charge storage layer 43. The photoconductive layer 42 for recording functions also as a photoconductive layer for readout.

In this radiation image detector 500, the charge storage layer 43 is provided directly on the second electrode layer 45 without providing the photoconductive layer 44 for readout. Since it is possible to form the linear charge storage layer 43 by vapor deposition, formation of the linear charge storage layer 43 is easy. In vapor deposition process, a metal mask or the like is used to selectively form a linear pattern. When the radiation image detector is structured in such a manner to provide the linear charge storage layer 43 on the photoconductive layer 44 for readout, a process of setting a metal mask for forming the linear charge storage layer 43 is necessary after vapor deposition of the photoconductive layer 44 for readout. Therefore, an operation in air between the vapor deposition process of the photoconductive layer 44 for readout and the vapor deposition process of the photoconductive layer 42 for recording may make the photoconductive layer 44 for readout deteriorate. Further, there is a risk of lowering the quality of the radiation image detector by mixture of a foreign substance between the photoconductive layers. However, when the photoconductive layer 44 for readout is not provided, as described above, it is possible to reduce the operation in air after vapor deposition of the photoconductive layer. Hence, it is possible to reduce the risk of deterioration in the quality, as described above.

The material of the photoconductive layer 42 for recording and the material of the charge storage layer 43 are similar to those in the aforementioned radiation image detector 400. Further, the linear structure of the charge storage layer 43 is similar to the aforementioned radiation image detector.

Next, the actions of recording and readout of a radiographic image by the radiation image detector 500 will be described.

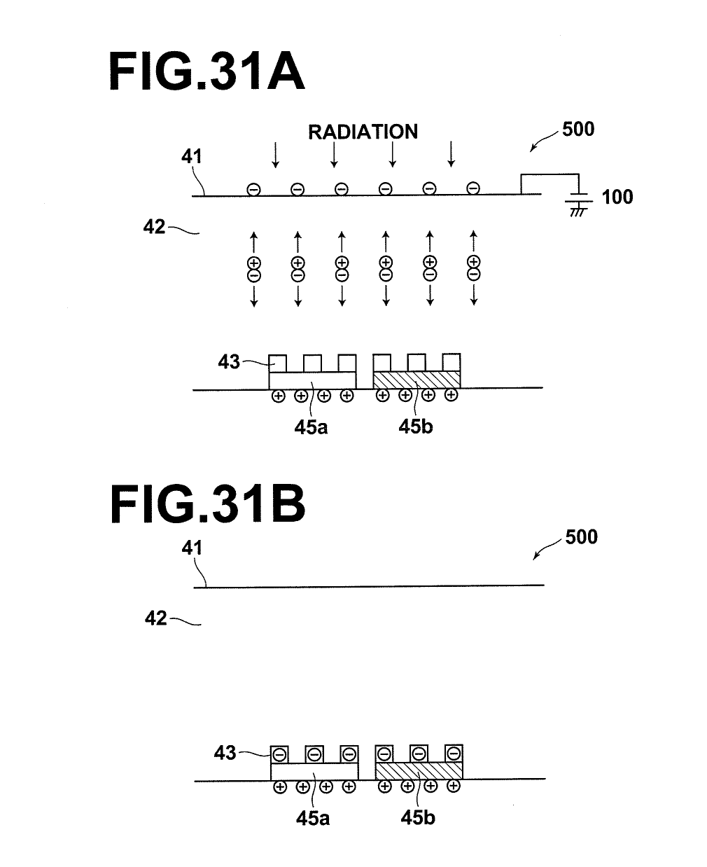

First, as illustrated in FIG. 31A, negative voltage is applied to the first electrode layer 41 of the radiation image detector 500 by a high voltage source 100. While the negative voltage is applied, radiation carrying self image G1 of the first grating 2 irradiates the radiation image detector 500 from the first electrode layer 41 side.

Further, radiation that has irradiated the radiation image detector 500 passes through the first electrode layer 41, and irradiates the photoconductive layer 42 for recording. An electron-hole pair is generated in the photoconductive layer 42 for recording by irradiation with the radiation. A positive charge of the charge pair is combined with a negative charge in the first electrode layer 41, and disappears. A negative charge of the charge pair is stored in the charge storage layer 43 as a latent image charge (please refer to FIG. 31B). Since the linear charge storage layer 43 in contact with the second electrode layer 45 is an insulating layer, charges that have reached the charge storage layer 43 are trapped there. The charges are stored and remain there, and do not reach the second electrode layer 45.

Here, in a manner similar to the radiation image detector 400 as described above, among charges generated in the photoconductive layer 42 for recording, only charges with the linear charge storage layer 43 present just under the charges are stored in the charge storage layer 43. By this action, the intensity of the self image of the first grating 2 is modulated by overlapping with the linear pattern of the charge storage layer 43. Further, image signals of a fringe image reflecting a distortion of the wavefront of self image G1 by subject B to be examined are stored in the charge storage layer 43.

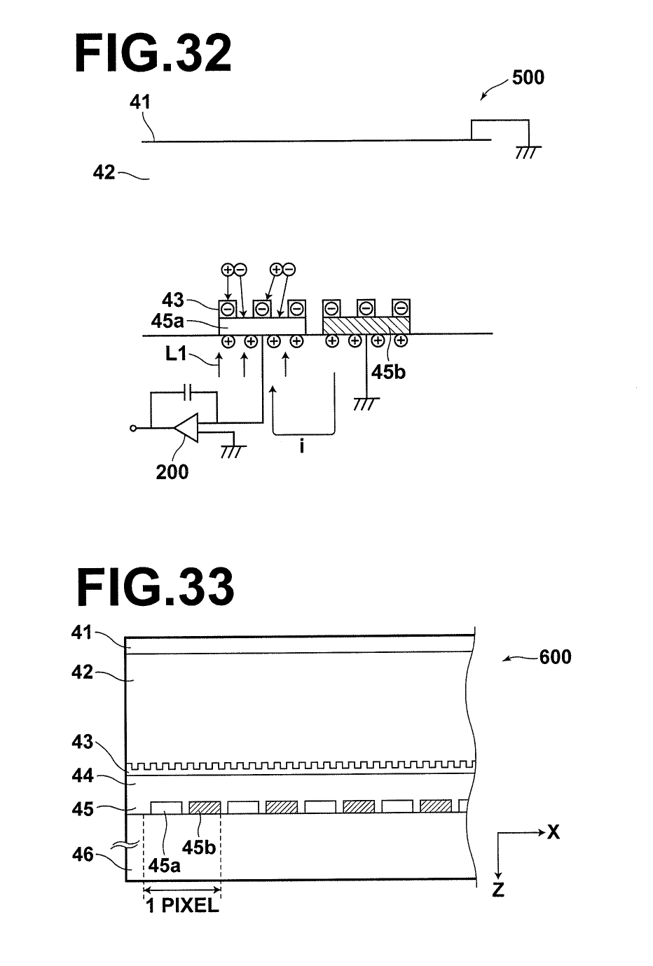

Further, as illustrated in FIG. 32, while the first electrode layer 41 is grounded, linear readout light L1 output from the linear readout light source 700 illuminates the radiation image detector 500 from the second electrode layer 45 side. The readout light L1 passes through the transparent linear electrodes 45a, and illuminates the photoconductive layer 42 for recording in the vicinity of the charge storage layer 43. Positive charges generated by illumination with the readout light L1 are attracted by the linear charge storage layer 43, and recombined with negative charges. Further, negative charges generated by illumination with the readout light L1 are attracted by the transparent linear electrodes 45a, and combined with positive charges in the transparent linear electrodes 45a, and positive charges in the opaque linear electrodes 45b through the charge amplifier 200 connected to the transparent linear electrodes 45a. Accordingly, an electric current flows to the charge amplifier 200. The electric current is integrated, and detected as image signals.

In the aforementioned radiation image detectors 400 and 500, the charge storage layer 43 is completely separated in linear form. However, it is not necessary that the charge storage layer 43 is formed in such a manner. For example, as in a radiation image detector 600 illustrated in FIG. 33, a linear pattern may be formed on a flat plate shape to form a grid-shape charge storage layer 43.

In a modified example of the aforementioned embodiment, self image G1 of the first grating 2 is arranged in such a manner to incline with respect to the second grating 3 so that plural fringe images are obtainable by performing one image acquisition operation. In a similar manner, self image G1 of the first grating 2 may be arranged in such a manner to incline with respect to the linear charge storage layer 43 in the radiation image detectors 400, 500.

When the radiation image detectors 400, 500 according to the modified example are used, an image for checking position shift is detected in a manner similar to the aforementioned embodiment. Further, the position is adjusted based on the frequency component of moiré in the image for checking position shift. In this case, since the second grating is integrated into the radiation image detector, the arrangement of the radiation image detectors 400, 500 or the first grating 2 is adjusted.

In the aforementioned embodiment, a case in which the radiation phase contrast imaging apparatus of the present invention is applied to a mammography and display system has been described. However, it is not necessary that the radiation phase contrast imaging apparatus of the present invention is applied to the mammography and display system. The radiation phase contrast imaging apparatus of the present invention may be applied to a radiography system for performing radiography on a subject (patient) in upright position, a radiography system for performing radiography on a subject in decubitus position, a radiography system that can perform radiography on a subject both in standing position and in decubitus position, a radiography system for performing so-called long-size radiography, and the like.

Further, the present invention may be applied to a radiation phase contrast CT (computed tomography) apparatus for obtaining a three-dimensional image, a stereoradigraphy apparatus for obtaining a stereo image that can provide stereoscopic view, and the like.

In the aforementioned embodiment, a phase contrast image is obtained, and an image that has been conventionally difficult to be rendered can be obtained. However, since conventional X-ray diagnostic imaging is based on absorption images, it is helpful for interpretation to refer to an absorption image corresponding a phase contrast image during image reading. For example, it is effective to use information represented by a phase contrast image to supplement information that could not be represented by an absorption image. The information represented by the phase contrast image may be used by superimposing or placing the absorption image and the phase contrast image one on the other by using appropriate processing, such as weighting, gradation (gray scale) and frequency processing.

However, if a phase contrast image and an absorption image are obtained in different radiography operations, it becomes difficult to place the phase contrast image and the absorption image one on the other in an excellent manner because a subject may move between the two radiography operations. Further, since the number of times of radiography increase, a burden on the patient increases. Further, in recent years, small-angle scattering images have drawn attention besides the phase contrast image and the absorption image. The small-angle scattering image can represent tissue conditions attributable to a fine structure (ultrastructure) in a tissue to be examined. The small-angle scattering image is a prospective new representation method for image diagnosis, for example, in cancers and circulatory diseases.

Therefore, an absorption image generation unit or a small-angle scattering image generation unit may be further provided in the computer 30. The absorption image generation unit generates an absorption image and the small-angle scattering image generation unit generates a small-angle scattering image from plural fringe images that have been obtained to generate the phase contrast image.

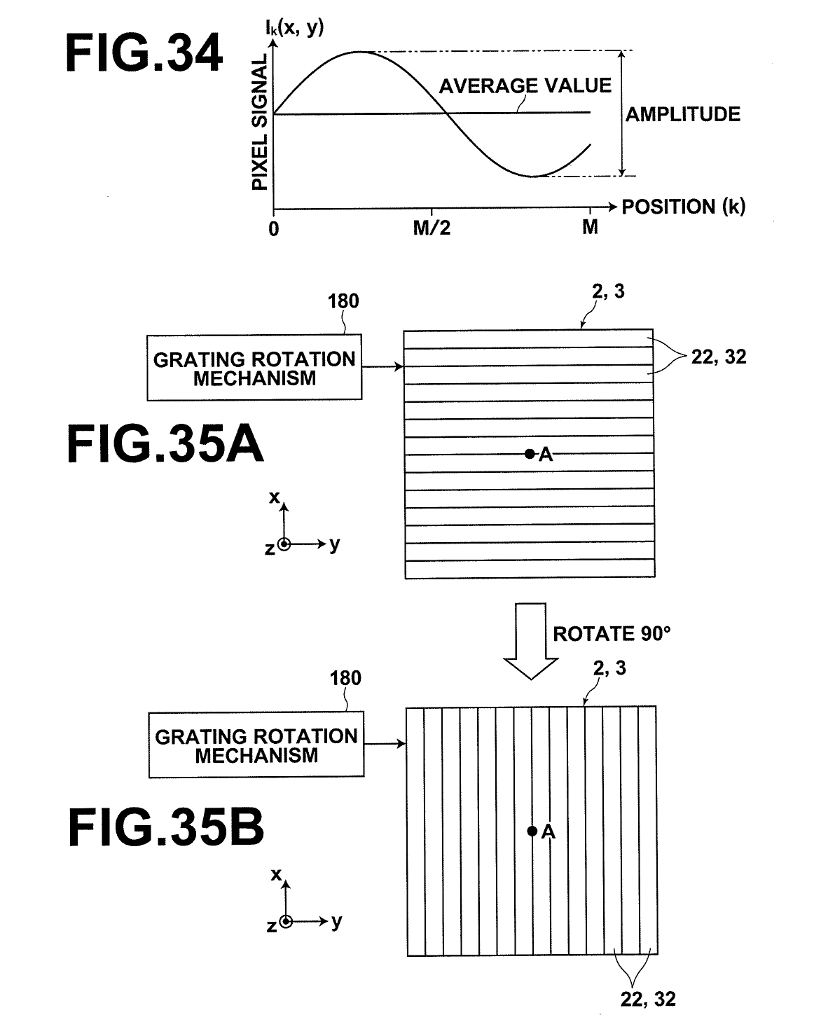

The absorption image generation unit calculates an average value by averaging, with respect to k, pixel signal Ik (x, y) obtainable for each pixel, as illustrated in FIG. 34, and forms an image. Accordingly, an absorption image is generated. Calculation of the average value may be performed by simply averaging pixel signal Ik(x,y) with respect to k. However, when the value of M is small, an error (difference) becomes large. Therefore, after fitting is performed on the pixel signal Ik (x, y) by a sinusoidal wave, an average value of the sinusoidal wave after fitting may be obtained. Further, it is not necessary to use the sinusoidal wave, and a square wave or a triangle wave may be used.

In generation of the absorption image, it is not necessary to use the average value. An addition value obtained by adding pixel signal Ik(x,y) with respect to k, or the like may be used as long as the value corresponds to the average value.

The small-angle scattering image generation unit calculates an amplitude value of pixel signal Ik (x, y) obtainable for each pixel, and forms an image. Accordingly, a small-angle scattering image is generated. Calculation of the amplitude value may be performed by obtaining a difference between the maximum value and the minimum value of the pixel signal Ik(x,y). However, when the value of M is small, an error (difference) becomes large. Therefore, after fitting is performed on the pixel signal Ik(x,y) by a sinusoidal wave, an amplitude value of the sinusoidal wave after fitting may be obtained. Further, it is not necessary to use the amplitude value to generate the small-angle scattering image, and a variance, a standard deviation or the like may be used as a value corresponding to dispersion with respect to an average value.

Further, a phase contrast image is based on a refraction component of X-rays in a periodic arrangement direction (X direction) of the members 22 of the first grating 2 and the members 32 of the second grating 3. Therefore, a refraction component of X-rays in a direction (Y direction) in which the members 22, 23 extend is not reflected in the phase contrast image. Specifically, the outline of a region along a direction (Y direction if the direction crosses X direction at right angles) crossing X direction is rendered, as a phase contrast image based on the refraction component in X direction. Therefore, the outline of the region along X direction, which does not cross X direction, is not rendered as the phase contrast image in X direction. Specifically, some region is not rendered depending on the shape or direction of the region of subject to be examined. For example, when the direction of a weight-bearing plane of an articular cartilage, such as a knee, is set to Y direction of XY directions, which are in-plane directions of a grating, rendering of the outline of a region in the vicinity of a weight-bearing plane (YZ plane) substantially along Y direction is supposed to be sufficient. However, rendering of tissues (a tendon, a ligament or the like) in the vicinity of cartilage, and the tissues crossing the weight-bearing plane and extending substantially along X direction, is supposed to be insufficient. If rendering is insufficient, it may be possible to perform an image acquisition again on the region which has been insufficiently rendered by moving the subject to be examined. However, if image acquisition is performed again, a burden on the subject to be examined and the work of the radiographer increase. Further, it is difficult to secure a position reproducibilityfor the previous image.

Therefore, as another example, a rotation mechanism 180 may be provided in the grid unit 16, as illustrated in FIGS. 35A, 35B. An imaginary line (optical axis A of X-rays) that is orthogonal to the grid planes of the first and second gratings 2, 3 and passes the centers of the grid planes may be used as a center of rotation, and the first grating 2 and the second grating 3 may be rotated, by an arbitrary angle, from a first direction illustrated in FIG. 35A to a second direction illustrated in FIG. 35B. Further, a phase contrast image may be generated in each of the first direction and the second direction. Such structure is advantageous.

When the apparatus is structured in such a manner, it is possible to eliminate the aforementioned problem in the position reproducibility. FIG. 35A illustrates the first direction of the first grating 2 and the second grating 3 in which the members 32 of the second grating 3 extend along Y direction. FIG. 35B illustrates the second direction of the first grating 2 and the second grating 3 in which the members 32 of the second grating 3 extend along X direction by rotating the first grating 2 and the second grating 3, by 90 degrees, from the state illustrated in FIG. 35a. However, the rotation angle of the first grating 2 and the second grating 3 may be an arbitrary angle as long as the inclination relationship between self image G1 of the first grating 2 and the second grating 3 is maintained. Further, rotation operations may be performed twice or more to change the direction to a third direction, a fourth direction and the like in addition to the first direction and the second direction. Further, a phase contrast image may be generated at each direction.

In the above descriptions, the first grating 2 and the second grating 3, which are one-dimensional gratings, are rotated. Instead, the first grating 2 and the second grating 3 may be structured as two-dimensional gratings composed of two-dimensionally-arranged extending members 22, 32, respectively.

When the apparatus is structured in such a manner, it is possible to obtain a phase contrast image for the first direction and the second direction by performing one radiography operation. Therefore, there is no influence of the motion of the subject between radiography operations and vibration of the apparatus, compared with the structure in which the one-dimensional gratings are rotated. Therefore, a more excellent position reproducibility is achievable. Further, since a rotation mechanism is not used, it is possible to simplify the apparatus, and to reduce the cost for production.

What is claimed is:

1. A radiographic apparatus comprising:
a first grating in which a grating structure is periodically arranged, and that forms a first periodic pattern image by passing radiation that has been emitted from a radiation source;
a second grating in which a grating structure is periodically arranged, and that forms a second periodic pattern image by receiving the first periodic pattern image, and
a radiation image detector that detects the second periodic pattern image formed by the second grating,
wherein the first grating and the second grating are structured in such a manner to be attachable to the radiographic apparatus and detachable therefrom, and
the radiographic apparatus further comprising:
a grid attachment/detachment detection unit that detects attachment and detachment of the first and second gratings; and
a preliminary irradiation control unit that controls the radiation source so that preliminary irradiation for detecting a relative positional deviation between the first and second gratings and the radiation image detector is performed when the grid attachment/detachment detection unit has detected attachment or detachment of the first and second gratings.

2. A radiographic apparatus comprising:
a first grating in which a grating structure is periodically arranged, and that forms a first periodic pattern image by passing radiation that has been emitted from a radiation source;
a second grating in which a grating structure is periodically arranged, and that forms a second periodic pattern image by receiving the first periodic pattern image; and
a radiation image detector that detects the second periodic pattern image formed by the second grating,
wherein the radiation image detector is structured in such a manner to be attachable to the radiographic apparatus and detachable therefrom, and
the radiographic apparatus further comprising:
a detector attachment/detachment detection unit that detects attachment and detachment of the radiation image detector; and
a preliminary irradiation control unit that controls the radiation source so that preliminary irradiation for detecting a relative positional deviation between the first and second gratings and the radiation image detector is performed when the detector attachment/detachment detection unit has detected attachment or detachment of the radiation image detector.

3. A radiographic apparatus, as defined in claim 1, wherein when attachment or detachment of the first and second gratings is detected, the preliminary irradiation control unit notifies that the preliminary irradiation will be performed, and
wherein when the preliminary irradiation control unit has received an instruction to start preliminary irradiation after the notification, the preliminary irradiation control unit performs the preliminary irradiation.

4. A radiographic apparatus, as defined in claim 2, wherein when attachment or detachment of the radiation image detector is detected, the preliminary irradiation control unit notifies that the preliminary irradiation will be performed, and
wherein when the preliminary irradiation control unit has received an instruction to start preliminary irradiation after the notification, the preliminary irradiation control unit performs the preliminary irradiation.

5. A radiographic apparatus, as defined in claim 1, the apparatus further comprising:
a person detection unit that detects whether no person is in a predetermined distance range,
wherein the preliminary irradiation control unit performs the preliminary irradiation when attachment or detachment of the first and second gratings is detected and when the person detection unit has detected that no person is in the predetermined distance range.

6. A radiographic apparatus, as defined in claim 2, the apparatus further comprising:
a person detection unit that detects whether no person is in a predetermined distance range,
wherein the preliminary irradiation control unit performs the preliminary irradiation when attachment or detachment of the radiation image detector is detected and when the person detection unit has detected that no person is in the predetermined distance range.

7. A radiographic apparatus, as defined in claim 1, the apparatus further comprising:
a position shift information obtainment unit that obtains information related to relative positional deviation between the first and second gratings and the radiation image detector based on an image for checking position shift that has been detected by the radiation image detector by the preliminary irradiation.

8. A radiographic apparatus, as defined in claim 2, the apparatus further comprising:
a position shift information obtainment unit that obtains information related to relative positional deviation between the first and second gratings and the radiation image detector based on an image for checking position shift that has been detected by the radiation image detector by the preliminary irradiation.

9. A radiographic apparatus, as defined in claim 7, the apparatus further comprising:
a position adjustment mechanism that adjusts the position of the first and second gratings or the radiation image detector based on the information related to relative positional deviation obtained by the position shift information obtainment unit.

10. A radiographic apparatus, as defined in claim 8, the apparatus further comprising:
a position adjustment mechanism that adjusts the position of the first and second gratings or the radiation image detector based on the information related to relative positional deviation obtained by the position shift information obtainment unit.

11. A radiographic apparatus, as defined in claim 7, wherein the position shift information obtainment unit obtains, as the information related to relative positional deviation, a frequency component of moiré generated in the image for checking position shift by the relative positional deviation between the first and second gratings and the radiation image detector.

12. A radiographic apparatus, as defined in claim 8, wherein the position shift information obtainment unit obtains, as the information related to relative positional deviation, a frequency component of moiré generated in the image for checking position shift by the relative positional deviation between the first and second gratings and the radiation image detector.

13. A radiographic apparatus, as defined in claim 1, the apparatus further comprising:
a scan mechanism that moves at least one of the first grating and the second grating in a direction orthogonal to a direction in which the at least one of the first grating and the second grating extends; and
an image generation unit that generates an image by using a plurality of radiographic image signals, each representing the second periodic pattern image detected by the radiation image detector with respect to each position of the at least one of the first grating and the second grating, while the at least one of the first grating and the second grating is moved by the scan mechanism.

14. A radiographic apparatus, as defined in claim 2, the apparatus further comprising:
a scan mechanism that moves at least one of the first grating and the second grating in a direction orthogonal to a direction in which the at least one of the first grating and the second grating extends; and
an image generation unit that generates an image by using a plurality of radiographic image signals, each representing the second periodic pattern image detected by the radiation image detector with respect to each position of the at least one of the first grating and the second grating, while the at least one of the first grating and the second grating is moved by the scan mechanism.

15. A radiographic apparatus, as defined in claim 1, wherein the first grating and the second grating are arranged in such a manner that a direction in which the first periodic pattern of the first grating extends and a direction in which the second grating extends incline relative to each other,
the apparatus further comprising:
an image generation unit that generates an image by using a radiographic image signal detected by the radiation image detector by irradiating a subject with the radiation.

16. A radiographic apparatus, as defined in claim 2, wherein the first grating and the second grating are arranged in such a manner that a direction in which the first periodic pattern of the first grating extends and a direction in which the second grating extends incline relative to each other,
the apparatus further comprising:
an image generation unit that generates an image by using a radiographic image signal detected by the radiation image detector by irradiating a subject with the radiation.

17. A radiographic apparatus, as defined in claim 15, wherein the image generation unit obtains, based on the radiographic image signal detected by the radiation image detector, radiographic image signals read out from different groups of pixel rows as radiographic image signals representing fringe images different from each other, and generates the image based on the obtained radiographic image signals representing the plurality of fringe images.

18. A radiographic apparatus, as defined in claim 16, wherein the image generation unit obtains, based on the radiographic image signal detected by the radiation image detector, radiographic image signals read out from different groups of pixel rows as radiographic image signals representing fringe images different from each other, and generates the image based on the obtained radiographic image signals representing the plurality of fringe images.

19. A radiographic apparatus, as defined in claim 1, the apparatus further comprising:
an image generation unit that performs Fourier transformation on a radiographic image signal detected by the radiation image detector by irradiating a subject with the radiation, and generates an image based on the result of the Fourier transformation.

20. A radiographic apparatus, as defined in claim 2, the apparatus further comprising:
an image generation unit that performs Fourier transformation on a radiographic image signal detected by the radiation image detector by irradiating a subject with the radiation, and generates an image based on the result of the Fourier transformation.

21. A radiographic image obtainment method for obtaining a radiographic image by using a radiographic apparatus including:
a first grating in which a grating structure is periodically arranged, and that forms a first periodic pattern image by passing radiation that has been emitted from a radiation source;
a second grating in which a grating structure is periodically arranged, and that forms a second periodic pattern image by receiving the first periodic pattern image; and
a radiation image detector that detects the second periodic pattern image formed by the second grating,
wherein the first grating and the second grating are structured in such a manner to be attachable to the radiographic apparatus and detachable therefrom, and
wherein the radiation source is controlled so that preliminary irradiation for detecting a relative positional deviation between the first and second gratings and the radiation image detector is performed when attachment or detachment of the first and second gratings is detected.

22. A radiographic image obtainment method for obtaining a radiographic image by using a radiographic apparatus including:
a first grating in which a grating structure is periodically arranged, and that forms a first periodic pattern image by passing radiation that has been emitted from a radiation source;
a second grating in which a grating structure is periodically arranged, and that forms a second periodic pattern image by receiving the first periodic pattern image; and
a radiation image detector that detects the second periodic pattern image formed by the second grating,
wherein the radiation image detector is structured in such a manner to be attachable to the radiographic apparatus and detachable therefrom, and
wherein the radiation source is controlled so that preliminary irradiation for detecting a relative positional deviation between the first and second gratings and the radiation image detector is performed when attachment or detachment of the radiation image detector is detected.
